(19) United States
(12) Patent Application Publication
(10) Pub. No.: US 2015/0358980 A1
(43) Pub. Date: Dec. 10, 2015

(54) MOBILE COMMUNICATION APPARATUS AND RADIO COMMUNICATION METHOD

(71) Applicant: FUJITSU LIMITED, Kawasaki-shi (JP)

(72) Inventor: Yasushi Hara, Kunitachi (JP)

(21) Appl. No.: 14/718,631

(22) Filed: May 21, 2015

(30) Foreign Application Priority Data
Jun. 4, 2014 (JP) 2014-115813

(51) Int. Cl. H04W 72/08; H04L 12/26

(52) U.S. Cl. CPC H04W 72/085; H04L 43/16; H04W 84/12

(57) ABSTRACT

A mobile communication apparatus includes a radio interface and a processor. The radio interface performs a search for an access point. When a signal level of a signal received from an access point detected by the search is greater than a first threshold, the processor allows a connection to the access point. When the signal level of the signal received from the access point is less than or equal to the first threshold, the processor determines an interval to the next search in accordance with whether the signal level is greater than a second threshold that is less than the first threshold.

### CROSS-REFERENCE TO RELATED APPLICATION

This application is based upon and claims the benefit of priority of the prior Japanese Patent Application No. 2014-115813, filed on Jun. 4, 2014, the entire contents of which are incorporated herein by reference.

### FIELD

The embodiments discussed herein are related to a mobile communication apparatus and a radio communication method.

### BACKGROUND

Mobile communication apparatuses connectable to a wireless local area network (LAN) are used today. Such a mobile communication apparatus searches for (scans for), for example, an available nearby access point (base station) from among access points scattered over the wireless LAN. When a desired access point is detected, the mobile communication apparatus connects to the access point to perform a communication. Some of the mobile communication apparatuses connectable to a wireless LAN are also connectable to another type of radio communication network such as a mobile phone network or the like, and perform communications using the other type of network when not connected to the wireless LAN.

With regard to wireless LANs, there has been proposed a method for handoff between access points. According to this handoff method, a mobile communication apparatus has two thresholds H and h (h<H) for the signal-to-noise ratio (SNR), and monitors the SNR of the connected access point. The mobile communication apparatus does not perform a handoff when the SNR is greater than the threshold H, and performs a handoff when the SNR is less than the threshold h. Further, when the SNR is greater than or equal to the threshold h and less than or equal to the threshold H, the mobile communication apparatus determines whether to perform a handoff based on an index value calculated from the SNR and the connection time.

There has also been proposed a radio communication terminal that performs a handover between access points. This radio communication terminal scans for a nearby access point at first intervals when the quality of communication with a connected access point is less than a “scan threshold” and equal to or greater than a “handover threshold” (“handover threshold”<“scan threshold”). Further, when the quality of communication with the connected access point is less than the “handover threshold”, the radio communication terminal scans for a nearby access point at second intervals shorter than the first intervals.

There has also been proposed a radio communication terminal that reduces power consumption by preventing unneeded scanning. This radio communication terminal determines that the radio communication terminal is stationary if the access point detected in a scan is the one detected in the previous scan and if the amount of change in received signal strength is within an allowable range. Then, in a subsequent scan, the radio communication terminal tracks only the radio channel of the access point having the highest received signal strength.

There has also been proposed a radio communication apparatus to be used for an ad-hoc network. This radio communication apparatus searches for a route by intermittently transmitting routing packets to its neighboring radio communication apparatuses. In doing so, the radio communication apparatus measures the strength of radio waves received from the neighboring radio communication apparatuses. The radio communication apparatus increases the interval between route searches when the measured radio wave strength is high, and reduces the interval between route searches when the radio wave strength is low.

There has also been proposed a mobile terminal apparatus capable of detecting a movement using an acceleration sensor. This mobile terminal apparatus searches for an access point at regular intervals when a movement of the mobile terminal apparatus is detected outside the coverage of a wireless LAN. On the other hand, the mobile terminal apparatus skips a search for an access point when a movement of the mobile terminal apparatus is not detected outside the coverage of the wireless LAN.

See, for example, Japanese Laid-open Patent Publications. No. 2005-27313, No. 2008-131587, No. 2008-148136, No. 2008-193322, and No. 2013-162207.

As a mobile communication apparatus moves toward an access point, the signal level (for example, the received signal strength) of a signal received from the access point is expected to increase gradually. In this case, it is preferable that the mobile communication apparatus be able to quickly connect to the access point when the status of radio connection to the access point is changed to a connectable state, that is, when the signal level exceeds a threshold for determining whether a connection is possible.

Connection to a nearby access point provides various advantages to the user of the mobile communication apparatus. For example, the transmission speed is expected to be improved when using a nearby access point, compared to that when using a wireless wide area network such as a mobile phone network or the like. Further, the power consumption of the mobile communication apparatus is expected to be reduced because the transmission time needed to transmit or receive a certain amount of data is reduced. The power consumption of the mobile communication apparatus is expected to be reduced also because the transmission power to a nearby access point is less than transmission power to a distant base station.

However, the interval between access point searches is often set to be long (for example, a dozen seconds at the beginning to 300 seconds). Therefore, even when there is an access point whose signal level has exceeded the threshold for determining whether a connection is possible, detection of the access point is delayed and hence establishment of a connection is delayed. For example, it is assumed that the signal level of a signal received from an access point is slightly less than the connection threshold at a certain search timing, but immediately after that, the signal level exceeds the connection threshold. In this case, the mobile communication apparatus waits for the next search timing (for example, for a dozen seconds to 300 seconds). Thus, the mobile communication apparatus might lose an opportunity to connect to the access point.

### SUMMARY

According to one aspect, there is provided a mobile communication apparatus including: a radio interface configured to perform a search for an access point; and a processor configured to allow a connection to an access point detected by the search when a signal level of a signal received from the detected access point is greater than a first threshold, and to determine an interval to a next search in accordance with whether the signal level is greater than a second threshold when the signal level is less than or equal to the first threshold that is less than first threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a mobile communication apparatus according to a first embodiment;

FIG. 2 illustrates a mobile communication system according to a second embodiment;

FIG. 3 is a block diagram illustrating an example of hardware of a mobile communication apparatus;

FIG. 4 illustrates an example of the interval between normal scans of a wireless LAN;

FIG. 5 illustrates an example of reducing the scan interval of the wireless LAN;

FIG. 6 illustrates a first example of an implementation for reducing the scan interval;

FIG. 7 illustrates a second example of an implementation for reducing the scan interval;

FIG. 8 illustrates a third example of an implementation for reducing the scan interval;

FIG. 9 illustrates an example of a breakdown of a normal scan and a capture scan;

FIG. 10 is a block diagram illustrating an example of a software configuration of the mobile communication apparatus;

FIG. 11 illustrates an example of a connection record table and a threshold table;

FIG. 12 is a sequence diagram illustrating an example of first capture scan control;

FIG. 13 is a flowchart illustrating an example of a first process performed by a reception strength determination unit;

FIG. 14 is a flowchart illustrating an example of a first process performed by a scan control unit;

FIG. 15 is a sequence diagram illustrating an example of second capture scan control;

FIGS. 16 and 17 are flowcharts illustrating an example of a second process performed by the scan control unit;

FIG. 18 is a sequence diagram illustrating an example of third capture scan control;

FIG. 19 is a flowchart illustrating an example of a part of a third process performed by the scan control unit;

FIG. 20 is a sequence diagram illustrating an example of fourth capture scan control;

FIG. 21 is a flowchart illustrating an example of a fourth process performed by the reception strength determination unit;

FIG. 22 is a flowchart illustrating an example of a fourth process performed by the scan control unit;

FIG. 23 illustrates another example of reducing the scan interval of the wireless LAN;

FIG. 24 is a sequence diagram illustrating an example of fifth capture scan control;

FIG. 25 is a flowchart illustrating an example of a fifth process performed by the scan control unit;

FIG. 26 is a sequence diagram illustrating an example of sixth capture scan control;

FIG. 27 is a flowchart illustrating an example of a sixth process performed by the reception strength determination unit; and

FIG. 28 is a flowchart illustrating an example of a sixth process performed by the scan control unit.

### DESCRIPTION OF EMBODIMENTS

Several embodiments will be described below with reference to the accompanying drawings, wherein like reference numerals refer to like elements throughout.

### (a) First Embodiment

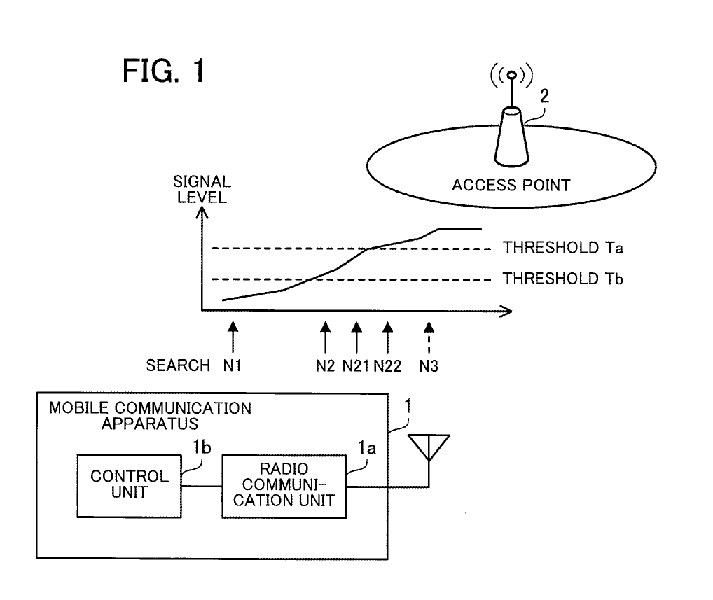

FIG. 1 illustrates a mobile communication apparatus 1 according to a first embodiment.

When the mobile communication apparatus 1 of the first embodiment is in the vicinity of an access point 2, the mobile communication apparatus 1 is able to perform a radio communication by connecting to the access point 2. The mobile communication apparatus 1 is a mobile radio terminal apparatus such as a mobile phone, a smartphone, a personal digital assistant (PDA), a tablet terminal, and the like, for example. The access point 2 is, for example, a radio communication apparatus on a wireless LAN, and is often called a “base station”. The access point 2 includes a radio interface that communicates wirelessly with the mobile communication apparatus 1, and a wired interface or another radio interface that communicates with a higher-level network. The access point 2 relays data from the mobile communication apparatus 1.

The mobile communication apparatus 1 includes a radio communication unit 1a and a control unit 1b. The radio communication unit 1a performs a search for an access point when the mobile communication apparatus 1 is not connected to the access point 2 (for example, when the mobile communication apparatus 1 is not connected to any access point). A search for an access point is often referred to as a “scan”. The control unit 1b controls the timing of a search by the radio communication unit 1a, and controls connection to an access point detected by the search.

The control unit 1b may include a processor such as a central processing unit (CPU), a digital signal processor (DSP), and the like. Further, the control unit 1b may include an application specific electronic circuit such as an application specific integrated circuit (ASIC), a field programmable gate array (FPGA), and the like. The processor executes a communication control program stored in a storage device such as a random access memory (RAM) and the like, for example. Note that a set of multiple processors (a multiprocessor) may be referred to as a “processor”.

When a search for an access point is performed by the radio communication unit 1a, the control unit 1b acquires the search result from the radio communication unit 1a. The search result includes information indicating a detected access point, and information indicating the measured signal level (for example, the received signal strength) of a signal received from the access point. The information indicating an access point may be, for example, an extended service set identifier (ESSID) or a basic service set identifier (BSSID). The information indicating the received signal strength may be, for example, a received signal strength indicator (RSSI).

When the access point 2 is detected by the search, the control unit 1b determines whether the signal level of the access point 2 is greater than a threshold Ta. The threshold Ta is a predetermined threshold for the signal level such as the received signal strength and the like. The threshold Ta corresponds to −80 dBm, for example. When the signal level is greater than the threshold Ta, the control unit 1b allows a connection to the detected access point 2. For example, the control unit 1b instructs the radio communication unit 1a to connect to the access point 2.

On the other hand, when the signal level of the access point 2 is less than or equal to the threshold Ta, the control unit 1b determines whether the signal level is greater than a threshold Tb. The threshold Tb is a predetermined threshold for the signal level such as the received signal strength and the like, and is less than the threshold Ta. The threshold Tb corresponds to −95 dBm, for example. The control unit 1b determines the interval to the next search for an access point in accordance with whether the signal level is greater than the threshold Tb. When the determined interval elapses, for example, the control unit 1b instructs the radio communication unit 1a to search for an access point again.

Regarding the search interval, when the signal level is greater than the threshold Tb, the control unit 1b may set the interval to the next search to be shorter than the interval that is set when the signal level is less than or equal to the threshold Tb.

For example, consider the case where the mobile communication apparatus 1 is moving toward the access point 2. In a search N1, the signal level of the access point 2 is less than or equal to the threshold Tb. Then, a search N2 is executed after a long first interval (for example, 300 seconds). In the search N2, the signal level is less than or equal to the threshold Ta and greater than the threshold Tb. At this stage, a connection to the access point 2 is not established yet. If the search interval is fixed, a search N3 is executed after another first interval. In the search N3, the signal level is greater than the threshold Ta. At this stage, the mobile communication apparatus 1 connects to the access point 2.

Actually, however, the signal level of the access point 2 exceeds the threshold Ta at a time point between the search N2 and the search N3. If the search interval is fixed to the first interval, the waiting time during which a connection to the access point 2 is not established despite a sufficiently high signal level is increased.

In view of the above, in the case where the signal level measured in the search N2 is greater than the threshold Tb, since the signal level is likely to exceed the threshold Ta soon, a search N21 is executed after a second interval (for example, 10 seconds) shorter than the first interval. In the search N21, the signal level is less than or equal to the threshold Ta and greater than the threshold Tb. Then, a search N22 is executed after another second interval. In the search N22, the signal level is greater than the threshold Ta. At this stage, the mobile communication apparatus 1 connects to the access point 2. Thus, it is possible to connect to the access point 2 earlier than the case of waiting until the search N3.

According to the mobile communication apparatus of the first embodiment, when the signal level of a signal that is received from the access point 2 detected by a search is not greater than a connectable level (threshold Ta), a determination is made as to whether the signal level is greater than the threshold Tb that is less than the threshold Ta. Then, the interval to the next search is determined in accordance with the determination result. Accordingly, even in the case where the normal interval between searches is increased in order to reduce power consumption, when the signal level is likely to exceed the threshold Ta soon, the frequency of search may be increased. This allows the mobile communication apparatus 1 to quickly connect to the access point 2, and makes it possible to benefit from radio communication using the access point 2 early. Further, when it is likely to take time for the signal level to exceed the threshold Ta, the frequency of search may be reduced. This makes it possible to reduce the power consumption of the mobile communication apparatus 1.

### (b) Second Embodiment

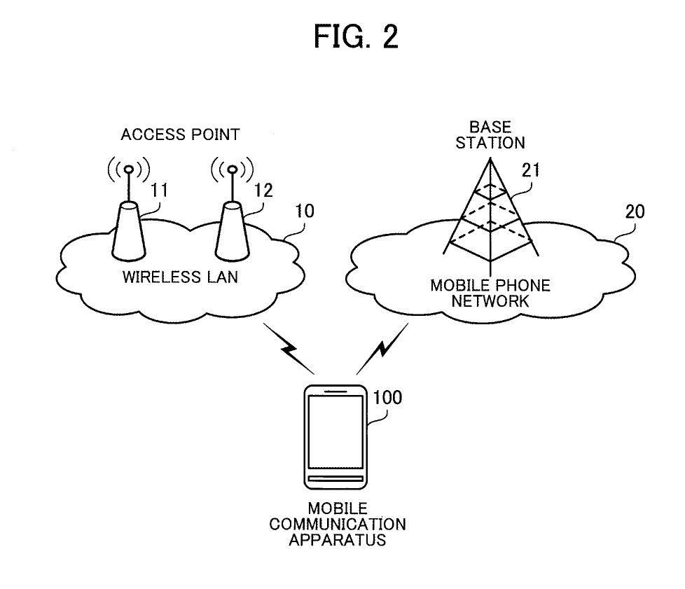

FIG. 2 illustrates a mobile communication system according to a second embodiment.

The mobile communication system of the second embodiment includes a wireless LAN 10, a mobile phone network 20, and a mobile communication apparatus 100. The wireless LAN 10 includes a plurality of access points including access points 11 and 12. The mobile phone network 20 includes a plurality of base stations including a base station 21. Note that the mobile communication apparatus 100 is an example of the mobile communication apparatus 1 of the first embodiment. The access point 11 is an example of the access point 2 of the first embodiment.

The access points 11 and 12 are radio communication apparatuses that perform radio communications conforming to the Institute of Electrical and Electronics Engineers (IEEE) 802.11 series of standards. The access points 11 and 12 are often called “base stations”. Examples of standards to be conformed to may include the IEEE802.11g, the IEEE802.11n, the IEEE802.11ac, and so on. The radio communication may conform to Wi-Fi. The access points 11 and 12 locally cover a part of the radio area of the mobile phone network 20. In other words, the radio areas of the wireless LAN 10 are scattered in the radio area of the mobile phone network 20. The access points 11 and 12 are connected to a wired network, and relay data between the mobile communication apparatus 100 and the wired network. For example, the access points 11 and 12 are connected to a data communication network that performs data communications using the Internet Protocol (IP).

The base station 21 is a radio communication apparatus that performs radio communications conforming to the 3rd Generation Partnership Project (3GPP) standards. Examples of standards to be conformed to may include Wideband Code Division Multiple Access (W-CDMA), Long Term Evolution (LTE), and so on. The base station 21 covers a wide radio area including the radio areas of the wireless LAN 10. The base station 21 may be regarded to form a macrocell. The base station 21 is connected to a wired network, and relays data between the mobile communication apparatus 100 and the wired network. For example, the base station 21 is connected to the data communication network to which the access points 11 and 12 are connected.

The mobile communication apparatus 100 is a mobile radio communication apparatus that includes both a radio interface using the wireless LAN 10 and a radio interface using the mobile phone network 20. The mobile communication apparatus 100 may be a user terminal apparatus operated by the user, such as a mobile phone, a smartphone, a PDA, a tablet terminal, and the like, for example. The mobile communication apparatus 100 is able to access to a server apparatus on the data communication network via the wireless LAN 10 or the mobile phone network 20, and acquire data such as Web pages, images, and videos.

For example, the mobile communication apparatus 100 receives data from the data communication network via the base station 21. However, upon entering the radio are of the access point 11, the mobile communication apparatus 100 connects to the access point 11, and receives data from the data communication network via the access point 11 instead of the base station 21. Similarly, upon entering the radio are of the access point 12, the mobile communication apparatus 100 connects to the access point 12, and receives data from the data communication network via the access point 12 instead of the base station 21. That is, when the mobile communication apparatus 100 is able to use the wireless LAN 10, the mobile communication apparatus 100 uses the wireless LAN 10 preferentially.

There are advantages for the mobile communication apparatus 100 in using the access points 11 and 12 instead of the base station 21. Generally, the access points 11 and 12 accommodate less mobile communication apparatuses than the base station 21. Therefore, the mobile communication apparatus 100 may use a wider communication band, and communicate at a higher speed. Further, since the communication time per unit data amount is less, the mobile communication apparatus 100 consumes less power when using the access point 11 or 12. Furthermore, when the mobile communication apparatus 100 is able to use the access point 11 or 12, the distance between the access point 11 or 12 and the mobile communication apparatus 100 is generally less than the distance between the base station 21 and the mobile communication apparatus 100. Therefore, the mobile communication apparatus 100 needs less transmission power and consumes less power when using the access point 11 or 12.

Note that each access point is assigned a BSSID and an ESSID as identification information. The BSSID is a 48-bit number for physically identifying each access point, and usually uses the medium access control (MAC) address of the access point. The ESSID is a string of a maximum of 32 alphanumeric characters for logically identifying a collection of one or more access points. For example, a plurality of access points for a wireless LAN service that is provided by a certain carrier may be assigned the same ESSID.

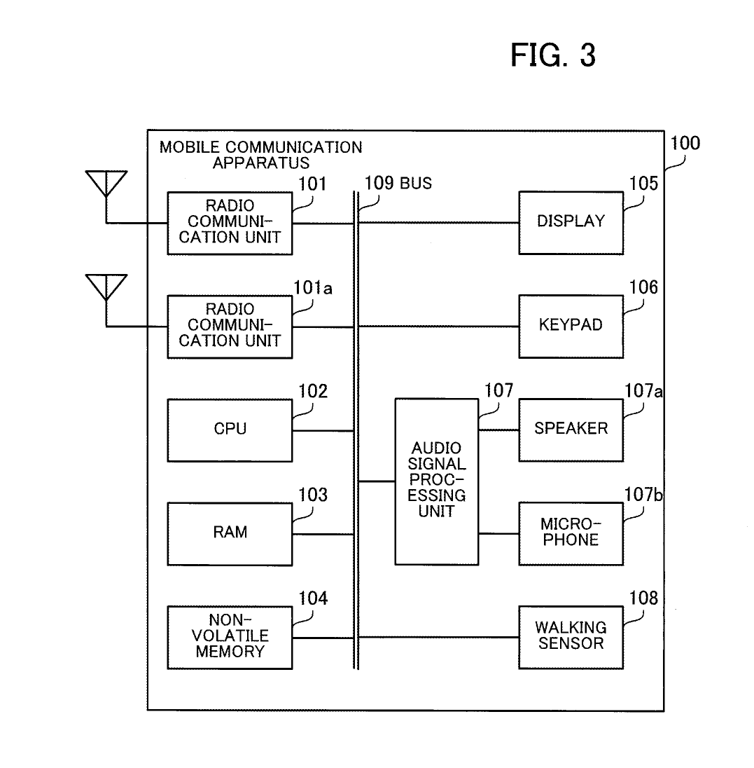

FIG. 3 is a block diagram illustrating an example of hardware of the mobile communication apparatus 100.

The mobile communication apparatus 100 includes radio communication units 101 and 101a, a CPU 102, a RAM 103, a non-volatile memory 104, a display 105, a keypad 106, an audio signal processing unit 107, a speaker 107a, a microphone 107b, a walking sensor 108, and a bus 109. The radio communication units 101 and 101a, the CPU 102, the RAM 103, the non-volatile memory 104, the display 105, the keypad 106, the audio signal processing unit 107, and the walking sensor 108 are connected to the bus 109. The speaker 107a and the microphone 107b are connected to the audio signal processing unit 107. Note that the radio communication unit 101 is an example of the radio communication unit 1a of the first embodiment. The CPU 102 (or a set of the CPU 102 and the RAM 103) is an example of the control unit 1b of the first embodiment.

The radio communication unit 101 is a radio interface that performs radio communications in accordance with the communication system of the wireless LAN 10. The radio communication unit 101 scans for an access point in response to an instruction from the CPU 102, and reports the scan result to the CPU 102. In the scan, the radio communication unit 101 measures the received signal strength of each of detected access points. In the second embodiment, RSSI is used as an index representing the received signal strength. The scan result includes the BSSID, ESSID, RSSI, and the like, of each detected access point. Further, the radio communication unit 101 performs a procedure to connect to the access point specified by the CPU 102. This enables data communication via the access point.

The radio communication unit 101a is a radio interface that performs radio communications in accordance with the communication system of the mobile phone network 20. The radio communication unit 101a connects to the base station 21 in response to an instruction from the CPU 102, and thus becomes able to perform a data communication via the base station 21. When the mobile communication apparatus 100 is not connected to any access point of the wireless LAN 10, data communication is performed using the radio communication unit 101a. On the other hand, when the mobile communication apparatus 100 is connected to any of the access points of the wireless LAN 10, data communication is performed using the radio communication unit 101.

The CPU 102 is a processor that executes instructions of a program. The CPU 102 loads at least part of a program and data stored in the non-volatile memory 104 into the RAM 103 so as to execute operations in accordance with the program. Note that the CPU 102 may include multiple processor cores, and the mobile communication apparatus 100 may include multiple processors. Thus, the processing described below may be executed in parallel by using multiple processors or processor cores. A set of multiple processors (a multiprocessor) may be referred to as a “processor”.

The RAM 103 is a volatile semiconductor memory that temporarily stores a program executed by the CPU 102 and data referred to by the program. The mobile communication apparatus 100 may include other types of memories than a RAM, and may include a plurality of memories.

The non-volatile memory 104 is a non-volatile storage device that stores programs of software (such as an operation system (OS), middleware, application software, and the like) and data. The programs include a communication control program that controls radio communications by the radio communication units 101 and 101a. The non-volatile memory 104 may be, for example, a flash memory. The mobile communication apparatus 100 may include other types of storage devices such as a hard disk drive (HDD) and the like, and may include a plurality of non-volatile storage devices.

The display 105 displays the content of a Web page, an image, a video, and the like, and also displays an operation screen in response to an instruction from the CPU 102. The display 105 may be any of various types of displays such as a liquid crystal display (LCD), an organic electro-luminescence display (GELD), and the like.

In order to reduce power consumption, the display 105 may turn on and off the screen in response to an instruction from the CPU 102. When the screen is on, power is supplied to the display 105, and an operation screen or the like is displayed. When the screen is off, power is not supplied to the display 105, and an operation screen or the like is not displayed. For example, if a predetermined type of event, such as an incoming call, an input by the user, and the like, occurs while the screen is off, the CPU 102 turns on the screen of the display 105. Further, for example, if a predetermined type of event does not occur for a predetermined time period while the screen is on, the CPU 102 turns off the screen of the display 105.

The keypad 106 is an input device that receives an input from the user. The keypad 106 includes one or more keys, and outputs an input signal indicating a key pressed by the user to the CPU 102. Note that the mobile communication apparatus 100 may include other types of input devices such as a touch panel and the like, in place of or in addition to the keypad 106. For example, a touch panel is disposed on the display 105. The touch panel detects a touch operation on the display 105, and reports the touched position to the CPU 102.

The audio signal processing unit 107 processes an audio signal in response to an instruction from the CPU 102. The audio signal processing unit 107 acquires digital audio data, converts the digital audio data into an analog audio signal, and outputs the analog audio signal to the speaker 107a. Further, the audio signal processing unit 107 acquires an analog audio signal from the microphone 107b, and converts the analog audio signal into digital audio data.

The speaker 107a acquires an electrical signal representing an audio signal, and converts the electrical signal into a physical vibration to reproduce sound. For example, when the user is talking on the mobile communication apparatus 100, the speaker 107a reproduces the voice of the person to whom the user is talking and the background noise. The microphone 107b converts the physical vibration of sound into an electrical signal, and outputs the electrical signal representing an audio signal to the audio signal processing unit 107. For example, when the user is talking on the mobile communication apparatus 100, the voice of the user and the background noise are input to the microphone 107b.

The walking sensor 108 is a sensor device that detects a walking motion of the user carrying the mobile communication apparatus 100. The walking sensor 108 includes, for example, a triaxial acceleration sensor in order to detect the walking status. A determination as to whether the user is walking is made in a comprehensive manner based on, for example, the magnitude, direction, and fluctuation cycle of acceleration, and the like. The walking sensor 108 provides walking information that indicates the current walking status of the user in response to a request from the CPU 102. The walking information includes, for example, information indicating whether the user is walking or stationary, information indicating the moving speed, and the like.

The following describes scanning for an access point of the wireless LAN 10.

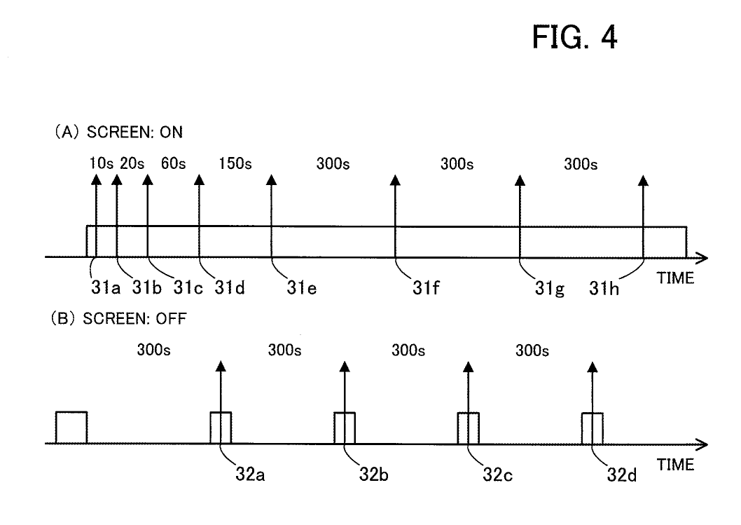

FIG. 4 illustrates an example of the interval between normal scans of the wireless LAN.

When the screen of the display 105 is on and the radio communication unit 101 is not connected to any access point, the mobile communication apparatus 100 continuously performs scanning until a connectable access point is detected. When a connectable access point is detected, the mobile communication apparatus 100 may display information on the detected access point (for example, ESSID) on the display 105 such that the user decides whether to connect to the access point. If the ESSID of the detected access point is the ESSID of an access point to which the mobile communication apparatus 100 has previously connected, the mobile communication apparatus 100 may automatically connect to the access point.

However, after the screen is switched from off to on, if no connectable access point is detected, the mobile communication apparatus 100 gradually increases the scan interval. This is because although an early connection to an access point is desired immediately after the screen is turned on, a reduction in power consumption of the mobile communication apparatus 100 is also desired. The scan interval starts with 10 seconds, and is increased to up to 300 seconds, for example. In the second embodiment, the scan illustrated in FIG. 4 may be referred to as a “normal scan” so as to be differentiated from a “capture scan” (described below). The normal scan may also be referred to as a “basic scan”, an “ordinary scan”, or the like.

If the screen of the display 105 is switched from off to on, the mobile communication apparatus 100 performs a normal scan 31a. If no connectable access point is detected in the normal scan 31a, the mobile communication apparatus 100 performs a normal scan 31b after 10 seconds. If no connectable access point is detected in the normal scan 31b, the mobile communication apparatus 100 performs a normal scan 31c after 20 seconds. If no connectable access point is detected in the normal scan 31c, the mobile communication apparatus 100 performs a normal scan 31d after 60 seconds. If no connectable access point is detected in the normal scan 31d, the mobile communication apparatus 100 performs a normal scan 31e after 150 seconds.

If no connectable access point is detected in the normal scan 31e, the mobile communication apparatus 100 performs a normal scan 31f after 300 seconds. If no connectable access point is detected in the normal scan 31f, since the scan interval is already set to the maximum value, the mobile communication apparatus 100 performs a normal scan 31g after 300 seconds. If no connectable access point is detected in the normal scan 31g, the mobile communication apparatus 100 performs a normal scan 31h after 300 seconds. After that, the mobile communication apparatus 100 performs normal scans at 300-second intervals until a connectable access point is detected.

Further, when the screen of the display 105 is off and the radio communication unit 101 is not connected to any access point, the mobile communication apparatus 100 continuously performs scanning until a connectable access point is detected. However, in the case where the screen is off, the weight of the desire for an early connection to an access point (the desire for a real-time connection) may be less than the case where the screen is on. Accordingly, after the screen is switched from on to off, the mobile communication apparatus 100 performs scans at longer fixed intervals (for example, the maximum value that is set when the screen is on).

If the screen of the display 105 is switched from on to off, the mobile communication apparatus 100 performs a normal scan 32a after 300 seconds from when the screen is turned off (from when the mobile communication apparatus 100 is ready for a scan). If no connectable access point is detected in the normal scan 32a, the mobile communication apparatus 100 performs a normal scan 32b after 300 seconds. If no connectable access point is detected in the normal scan 32b, the mobile communication apparatus 100 performs a normal scan 32c after 300 seconds. If no connectable access point is detected in the normal scan 32c, the mobile communication apparatus 100 performs a normal scan 32d after 300 seconds. After that, the mobile communication apparatus 100 performs normal scans at 300-second intervals.

Note that in FIG. 4, the horizontal axis represents time, and time proceeds toward the right. Further, in FIG. 4, the vertical axis represents power consumption, and power consumption increases toward the top. Each vertical arrow indicates the power consumed by a scan. Each rectangle indicates the power consumed for execution of a program by the CPU 102, displaying a screen on the display 105, and so on, excluding the power consumed for radio communication with the wireless LAN 10. When the screen is off, the CPU 102 is intermittently suspended to reduce power consumption.

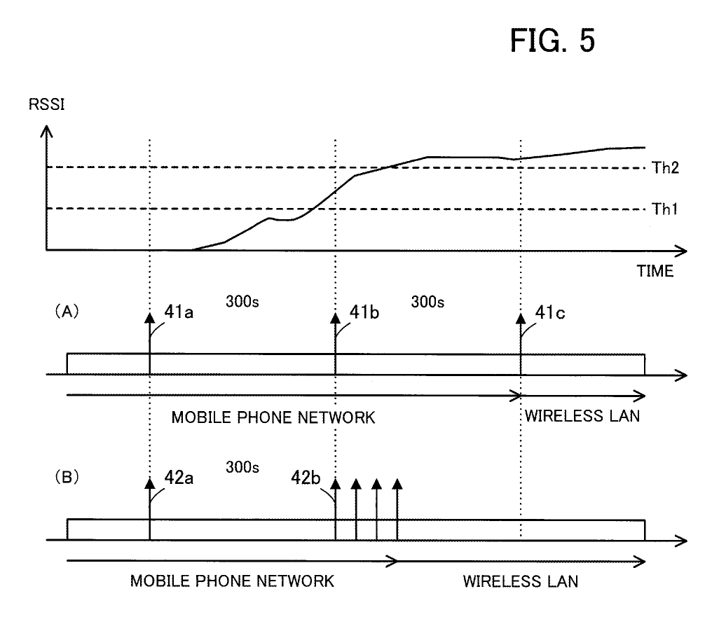

FIG. 5 illustrates an example of reducing the scan interval of the wireless LAN 10.

The following describes the case where the user carrying the mobile communication apparatus 100 walks from the outside of the radio area of the access point 11 toward the inside of the radio area. The RSSI of the received signal from the access point 11 which is measured by the mobile communication apparatus 100 is expected to increase gradually. It is assumed that while the user is walking, the mobile communication apparatus 100 continuously receives data from the wireless LAN 10 or the mobile phone network 20. For example, while the user is walking, the user views a Web page using a Web browser. Further, it is assumed that the mobile communication apparatus 100 has not been connected to any other access points than the access point 11, and a sufficient period of time has elapsed after the screen was turned on.

In the case of considering only the normal scan of FIG. 4, the mobile communication apparatus 100 performs a normal scan 41a. In the normal scan 41a, the access point 11 is not detected. Then, the mobile communication apparatus 100 performs a data communication using the mobile phone network 20.

After 300 seconds, the mobile communication apparatus 100 performs a normal scan 41b. In the normal scan 41b, although the access point 11 is detected, the measured RSSI of the access point 11 is less than a threshold Th2. The threshold Th2 is a threshold used for determining whether to connect to the detected access point. Then, the mobile communication apparatus 100 continues to perform a data communication using the mobile phone network 20. Note that the RSSI measured in the normal scan 41b is greater than a threshold Th1 that is less than the threshold Th2.

After 300 seconds, the mobile communication apparatus 100 performs a normal scan 41c. In the normal scan 41c, the measured RSSI of the access point 11 is greater than the threshold Th2. Then, the mobile communication apparatus 100 connects to the access point 11, and performs a data communication using the wireless LAN 10 instead of the mobile phone network 20. Thus, the transmission speed of the data communication is expected to be improved, and the power consumption of the mobile communication apparatus 100 is expected to be reduced.

The RSSI of the access point 11 gradually increases from the time point of the normal scan 41b, and exceeds the threshold Th2 at a time point between the normal scan 41b and the normal scan 41c. However, there is an interval of 300 seconds from the normal scan 41b to the next scan (the normal scan 41c), and therefor there is a delay in determining that a connection to the access point 11 is possible. This delays the timing of using the wireless LAN 10 instead of the mobile phone network 20. In view of the above, the second embodiment aims to quickly connect to the access point 11, thereby further improving the transmission speed and reducing the power consumption.

In the case of considering also other types of scans than the normal scan of FIG. 4, the mobile communication apparatus 100 performs a normal scan 42a. In the normal scan 42a, as in the case of the normal scan 41a, the access point 11 is not detected. After 300 seconds, the mobile communication apparatus 100 performs a normal scan 42b. In the normal scan 42b, as in the case of the normal scan 41b, the measured RSSI of the access point 11 is less than or equal to the threshold Th2 and greater than the threshold Th1. Then, the mobile communication apparatus 100 continuously performs intermittent scanning for an access point.

Since the RSSI is greater than the threshold Th1, the RSSI is likely to exceed the threshold Th2 before the lapse of 300 seconds from the normal scan 42b. In this case, it is preferable that, after the RSSI exceeds the threshold Th2, the mobile communication apparatus 100 detect this fact as soon as possible. In view of this, instead of performing the next scan after an interval of 300 seconds, the mobile communication apparatus 100 performs the next scan after an interval of less than 300 seconds. For example, the mobile communication apparatus 100 performs a “capture scan” after a 10-second interval from the normal scan 42b. The capture scan is a scan different from the normal scan that is performed at the timing illustrated in FIG. 4. The capture scan is a temporary scan that is performed when an access point that is likely to become connectable soon is detected. The capture scan may also be referred to as an “additional scan”, an “early scan”, a “previous capture scan”, or the like.

The capture scan may be performed two or more times after the normal scan 42b. In the example of FIG. 5, the mobile communication apparatus 100 performs capture scans at 10-second intervals, and detects that the RSSI of the access point 11 has exceeded the threshold Th2 in the third capture scan. Then, the mobile communication apparatus 100 connects to the access point 11, and performs a data communication using the wireless LAN 10 instead of the mobile phone network 20. Thus, it is possible to start using the wireless LAN 10 earlier than the case of waiting until the normal scan 41c after the normal scan 41b.

The following describes a method of reducing the scan interval with reference to specific examples.

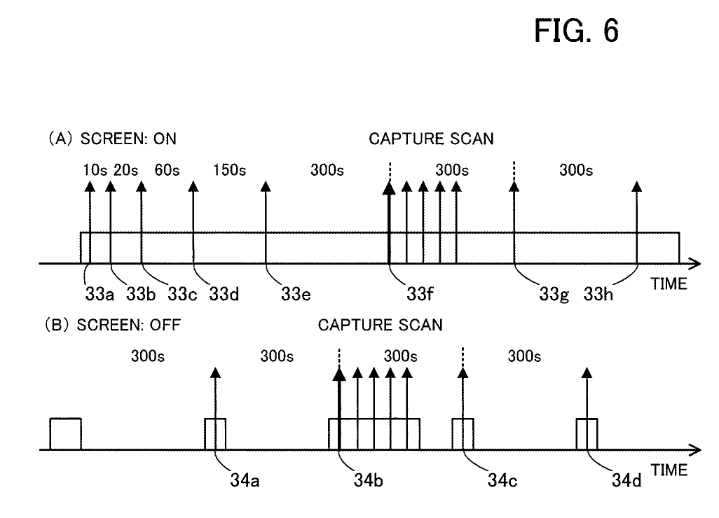

FIG. 6 illustrates a first example of an implementation for reducing the scan interval.

In the first example, when an access point with an RSSI less than or equal to the threshold Th2 and greater than the threshold Th1 is detected in a normal scan, the mobile communication apparatus 100 determines whether the interval to the next normal scan is greater than or equal to a predetermined interval (for example, 60 seconds). If the interval to the next normal scan is greater than or equal to the predetermined interval (for example, if the interval is 60 seconds, 150 seconds, or 300 seconds), the mobile communication apparatus 100 performs a capture scan in addition to normal scans. Thus, a capture scan is inserted between the current normal scan and the next normal scan, without affecting the timing of the normal scans. On the other hand, if the interval to the next normal scan is less than the predetermined interval (for example, if the interval is 10 seconds or 20 seconds), the mobile communication apparatus 100 waits for the next normal scan without inserting a capture scan.

For example, if the screen is switched from off to on, the mobile communication apparatus 100 performs a normal scan 33a. If the RSSI measured in the normal scan 33a is less than or equal to the threshold Th1, the mobile communication apparatus 100 performs a normal scan 33b after 10 seconds. If the RSSI measured in the normal scan 33b is less than or equal to the threshold Th1, the mobile communication apparatus 100 performs a normal scan 33c after 20 seconds. Then, in a similar manner, the mobile communication apparatus 100 performs a normal scan 33d after 60 seconds from the normal scan 33c, performs a normal scan 33e after 150 seconds from the normal scan 33d, and performs a normal scan 33f after 300 seconds from the normal scan 33e.

If the RSSI measured in the normal scan 33f is less than or equal to the threshold Th2 and greater than the threshold Th1, the mobile communication apparatus 100 determines to insert a capture scan because the interval to the next normal scan is 60 seconds or more. Then, the mobile communication apparatus 100 performs a capture scan after 10 seconds from the normal scan 33f. If the RSSI measured in the capture scan is less than or equal to the threshold Th2 (if a connection to the access point is not established yet), the mobile communication apparatus 100 performs a capture scan after another 10 seconds. As will be described below, when a certain condition is satisfied, the capture scans at 10-second intervals end. In the example of FIG. 6, the capture scan is performed four times after the normal scan 33f.

If a connection to the access point 11 is not established even by the capture scans, the mobile communication apparatus 100 performs a normal scan 33g after 300 seconds from the normal scan 33f. If the RSSI measured in the normal scan 33g is less than or equal to the threshold Th1, the mobile communication apparatus 100 performs a normal scan 33h after 300 seconds. After that, the mobile communication apparatus 100 performs normal scans at 300-second intervals. Between normal scans, capture scans at 10-second intervals may be inserted.

On the other hand, if the screen is switched from on to off, the mobile communication apparatus 100 performs a normal scan 34a after 300 seconds from when the screen of the display 105 is turned off or from when the CPU 102 is suspended. If the RSSI measured in the normal scan 34a is less than or equal to the threshold Th1, the mobile communication apparatus 100 performs a normal scan 34b after 300 seconds. If the RSSI measured in the normal scan 34b is less than or equal to the threshold Th2 and greater than the threshold Th1, the mobile communication apparatus 100 performs capture scans at 10-second intervals as described above. If a connection to the access point 11 is not established even by the capture scans, the mobile communication apparatus 100 performs a normal scan 34c after 300 seconds from the normal scan 34b. If the RSSI measured in the normal scan 34c is less than or equal to the threshold Th1, the mobile communication apparatus 100 performs a normal scan 34d after 300 seconds.

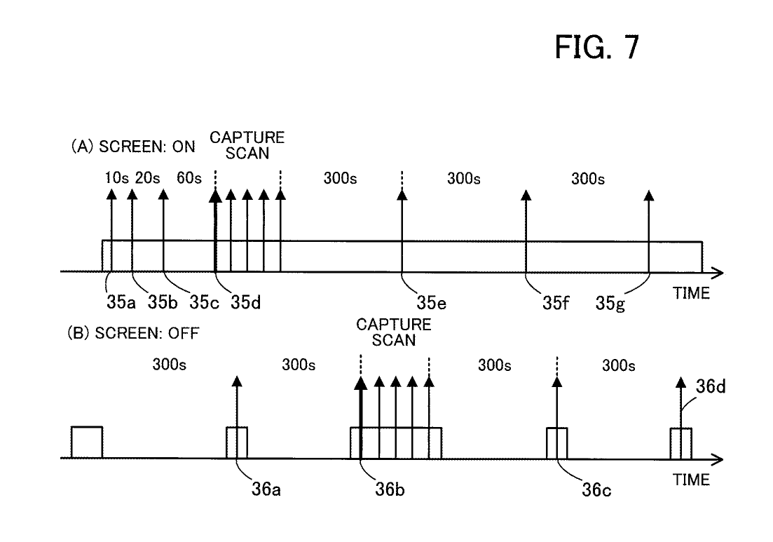

FIG. 7 illustrates a second example of an implementation for reducing the scan interval.

In the second example, when an access point with an RSSI less than or equal to the threshold Th2 and greater than the threshold Th1 is detected in a normal scan, the mobile communication apparatus 100 executes a capture scan regardless of the length of the interval to the next normal scan. While the mobile communication apparatus 100 repeats a capture scan, execution of a normal scan is suspended. If the capture scans at 10-second intervals end without establishing a connection to the access point 11, the mobile communication apparatus 100 restarts a normal scan with reference to the timing of the last capture scan. The interval between normal scans after the restart is set to, for example, the maximum value (300 seconds). However, the interval immediately after the restart may be reset to the length of the interval that is set when the last normal scan is performed.

For example, if the screen is switched from off to on, the mobile communication apparatus 100 performs a normal scan 35a, performs a normal scan 35b after 10 seconds, performs a normal scan 35c after further 20 seconds, and performs a normal scan 35d after further 60 seconds. If the RSSI measured in the normal scan 35d is less than or equal to the threshold Th2 and greater than the threshold Th1, the mobile communication apparatus 100 performs capture scans at 10-second intervals until a certain condition is satisfied. If a connection to the access point 11 is not established even by the capture scans, the mobile communication apparatus 100 performs a normal scan 35e after 300 seconds from the last capture scan. Then, the mobile communication apparatus 100 performs a normal scan 35f after 300 seconds, and performs a normal scan 35g after further 300 seconds.

On the other hand, if the screen is switched from on to off, the mobile communication apparatus 100 performs a normal scan 36a after 300 seconds, and performs a normal scan 36b after further 300 seconds. If the RSSI measured in the normal scan 36b is less than or equal to the threshold Th2 and greater than the threshold Th1, the mobile communication apparatus 100 performs capture scans at 10-second intervals until a certain condition is satisfied. If a connection to the access point 11 is not established even by the capture scans, the mobile communication apparatus 100 performs a normal scan 36c after 300 seconds from the last capture scan. Then, the mobile communication apparatus 100 performs a normal scan 36d after 300 seconds.

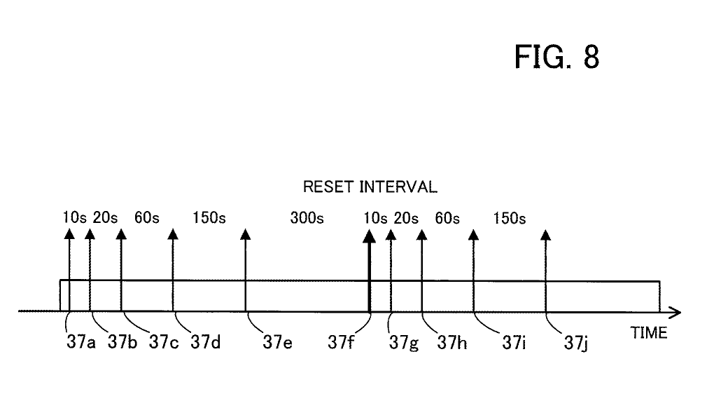

FIG. 8 illustrates a third example of an implementation for reducing the scan interval.

In the third example, when the screen is on, if an access point with an RSSI less than or equal to the threshold Th2 and greater than the threshold Th1 is detected in a normal scan, the mobile communication apparatus 100 resets the interval between normal scans to the initial value. For example, even if the scan interval is increased to the maximum value of 300 seconds, the scan interval is reset to the initial value of 10 seconds, and then is increased gradually. In the third example, a capture scan different from a normal scan does not have to be executed. Note that the mobile communication apparatus 100 may reset the scan interval only when the interval to the next normal scan is greater than or equal to a predetermined interval (for example, when the interval is 60 seconds, 150 seconds, or 300 seconds).

For example, if the screen is switched from off to on, the mobile communication apparatus 100 performs a normal scan 37a. The mobile communication apparatus 100 performs a normal scan 37b after 10 seconds, performs a normal scan 37c after further 20 seconds, performs a normal scan 37d after further 60 seconds, performs a normal scan 37e after further 150 seconds, and performs a normal scan 37f after further 300 seconds. If the RSSI measured in the normal scan 37f is less than or equal to the threshold Th2 and greater than the threshold Th1, the mobile communication apparatus 100 resets the scan interval. Then, the mobile communication apparatus 100 performs a normal scan 37g after 10 seconds, performs a normal scan 37h after further 20 seconds, performs a normal scan 37i after further 60 seconds, and performs a normal scan 37j after further 150 seconds.

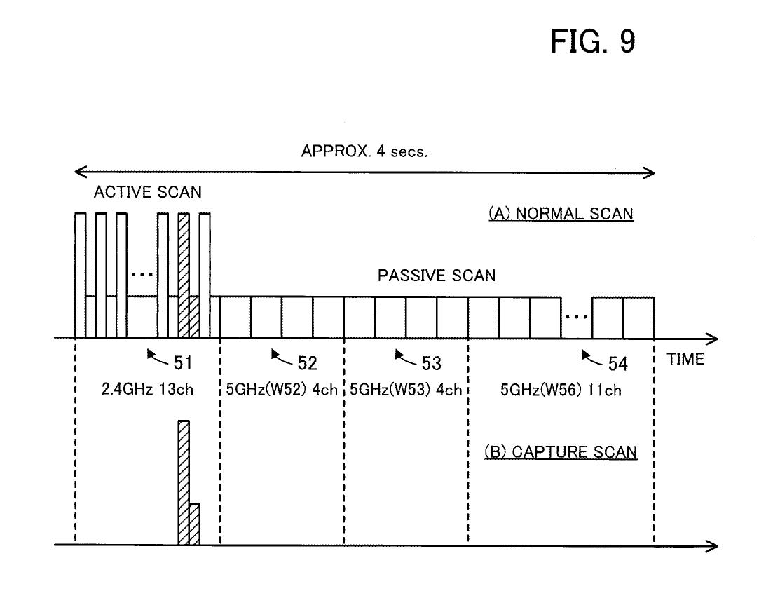

FIG. 9 illustrates an example of a breakdown of a normal scan and a capture scan.

Each normal scan performed in FIGS. 6 through 8 includes scan periods 51 through 54. In the scan period 51, an active scan is performed on thirteen channels (frequencies) in the 2.4 GHz band. In the scan period 52, a passive scan is performed on four channels at 5.15 through 5.25 GHz (so-called W52) in the 5 GHz band. In the scan period 53, a passive scan is performed on four channels at 5.25 through 5.35 GHz (so-called W53) in the GHz band. In the scan period 54, a passive scan is performed on eleven channels at 5.47 through 5.725 GHz (so-called W56) in the 5 GHz band. The time needed to perform a single normal scan is approximately 4 seconds.

In the active scan, a broadcast scan or a unicast scan is performed. In the broadcast scan, the mobile communication apparatus 100 transmits a probe request not specifying an ESSID. An access point having received the probe request returns a probe response including its BSSID and ESSID. In the unicast scan, the mobile communication apparatus 100 transmits a probe request specifying a specific ESSID. An access point having received the probe request returns a probe response including its BSSID and ESSID only when the specified ESSID matches its ESSID. The assumed scan in the scan period 51 is mainly a broadcast scan. The time needed to transmit a probe request and receive a probe response on a single channel is approximately 15 through 30 milliseconds.

In the passive scan, the mobile communication apparatus 100 detects a beacon transmitted from an access point. The access point broadcasts control data called a beacon at predetermined intervals (for example, at 102.4-millisecond intervals). The beacon includes information corresponding to a probe response for an active scan, such as BSSID, ESSID, and the like. The time needed to detect a beacon on a single channel is approximately 220 milliseconds.

On the other hand, each capture scan in FIGS. 6 and 7 is performed only on a channel on which an access point is detected in the immediately preceding normal scan, or only on a channel with an RSSI greater than the threshold Th1. For example, it is assumed that an access point is detected only on channel 12 in the 2.4 GHz band. Then, in the subsequent capture scan, the mobile communication apparatus 100 transmits a probe request only on channel 12 in the 2.4 GHz band. In this case, since the ESSID of the access point is specified in the immediately preceding normal scan, the assumed active scan is mainly a unicast scan.

As mentioned above, in the examples of FIGS. 6 and 7, once a capture scan starts, the capture scan is repeated at 10-second intervals until a certain condition (termination condition) is satisfied. The termination condition of the capture scan may be, for example, any of the following 6 patterns.

Termination Condition #1: The capture scan is performed four times. Termination Condition #2: The latest RSSI is less than or equal to the threshold Th1. Termination Condition #3: The capture scan is performed four or more times, and the latest RSSI is less than or equal to the threshold Th1. Termination Condition #4: The capture scan is performed 4n times, and a walking motion of the user is not detected in the 4n-th capture scan (n=1, 2, 3, and so on, a determination is made in each capture scan). Termination Condition #5: The capture scan is performed four times, and a walking motion of the user is not detected in the fourth capture scan. Or, the capture scan is performed four or more times; a walking motion of the user is detected in the fourth capture scan; and the latest RSSI is less than or equal to the threshold Th1. Termination Condition #6: The capture scan is performed four times. However, the counter is reset each time a new access point is detected.

The following describes scan control performed by the mobile communication apparatus 100. Note that, among the methods of reducing the scan interval illustrated in FIGS. 7 through 9, the methods illustrated in FIGS. 6 and 7 will be discussed. Further, among the termination conditions #1 through #6 described above, the termination conditions #1, #3, #5, and #6 will be described in detail.

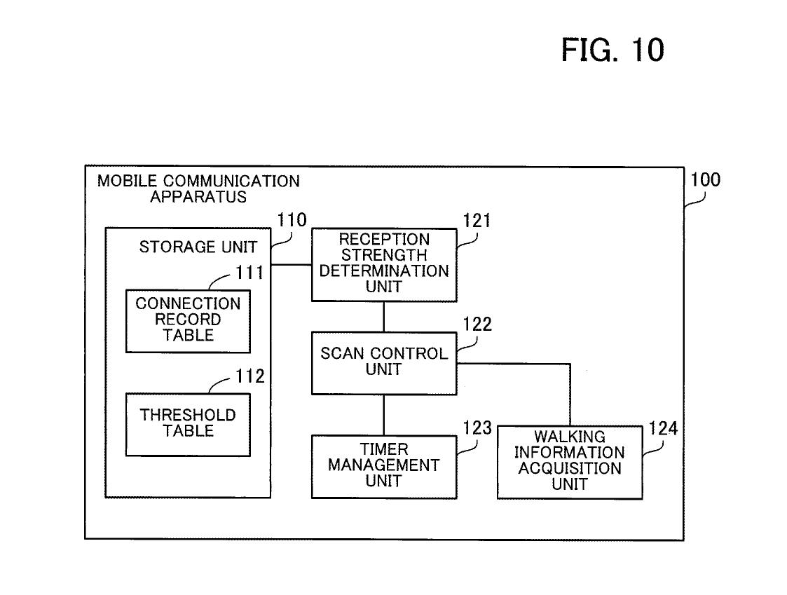

FIG. 10 is a block diagram illustrating an example of a software configuration of the mobile communication apparatus 100.

The mobile communication apparatus 100 includes a storage unit 110, a reception strength determination unit 121, a scan control unit 122, a timer management unit 123, and a walking information acquisition unit 124. The storage unit 110 is implemented as a storage area reserved in the RAM 103 or the non-volatile memory 104, for example. The reception strength determination unit 121, the scan control unit 122, the timer management unit 123, and the walking information acquisition unit 124 are implemented as modules of a program executed by the CPU 102, for example.

The storage unit 110 stores control information used for controlling scan for an access point and controlling connection to an access point. The control information includes a connection record table 111 and a threshold table 112. The connection record table 111 stores the ESSID of an access point to which the mobile communication apparatus 100 has previously connected. The connection record table 111 is appropriately updated by the CPU 102. The threshold table 112 stores various thresholds (thresholds Th1 and Th2 described above, and the like) used for scan control and connection control. The thresholds may be set in advance at the time of manufacture or shipment of the mobile communication apparatus 100. Further, the thresholds may be updated when software is updated after shipment of the mobile communication apparatus 100.

When the radio communication unit 101 performs a scan (including a normal scan and a capture scan), the reception strength determination unit 121 acquires the scan result from the radio communication unit 101. The scan result includes the BSSID and ESSID of the access point detected by the radio communication unit 101, the RSSI of the access point measured by the radio communication unit 101, and the like.

Having acquired the scan result, the reception strength determination unit 121 compares the ESSID registered in the connection record table 111 with the ESSID included in the scan result. Further, the reception strength determination unit 121 compares the thresholds registered in the threshold table 112 with the RSSI included in the scan result. Then, the reception strength determination unit 121 issues a notification to the scan control unit 122 in accordance with the result of the comparisons. The notification includes a notification of “the start of a connection”, a notification of “a capturable state”, and a notification of “a failed detection”. The notification of the start of a connection indicates that an immediately connectable access point is detected. The notification of a capturable state indicates that an access point that is likely to become connectable soon is detected. The notification of a failed detection indicates that no such access point is detected.

The scan control unit 122 controls scan for an access point and connection by the radio communication unit 101. When it is time to perform a scan, the scan control unit 122 instructs the radio communication unit 101 to perform a scan. After the radio communication unit 101 performs a scan, the scan control unit 122 obtains a notification of the start of a connection, a capturable state, a failed detection, or the like from the reception strength determination unit 121. The scan control unit 122 determines to establish a connection to the detected access point or determines a length of the interval to the next scan, in accordance with the obtained notification.

If the scan control unit 122 determines to establish a connection, the scan control unit 122 specifies the access point and instructs the radio communication unit 101 to connect to the specified access point. The connection to the access point is made upon obtaining a notification of the start of a connection. On the other hand, if the scan control unit 122 does not determine to establish a connection, the scan control unit 122 waits until the timing of the next scan, using the timer management unit 123. The next scan may be a normal scan, or may be a capture scan. The interval to the next normal scan is calculated based on the rules illustrated in FIG. 4, in accordance with whether the screen of the display 105 is on or off. A capture scan is performed upon receiving a notification of a capturable state.

The timer management unit 123 manages the timing of the next scan, using a timer mechanism (for example, a timer function of the OS, a hardware timer, or the like). The timer management unit 123 receives a timer request including a specified period of time from the scan control unit 122. When the specified period of time elapses from the reception of the timer request, the timer management unit 123 outputs a timer interruption to the scan control unit 122. The scan control unit 122 is able to recognize the timing of a scan based on the timer interruption from the timer management unit 123. Note that the timer management unit 123 may manage the timing of the next normal scan and the timing of the next capture scan separately (in parallel) in the case of FIG. 6 and the like.

The walking information acquisition unit 124 acquires walking information from the walking sensor 108, and provides the walking information to the scan control unit 122. The walking information includes information indicating whether the status of the user is either “walking” or “stationary”. The walking information may be used for controlling whether to perform a capture scan.

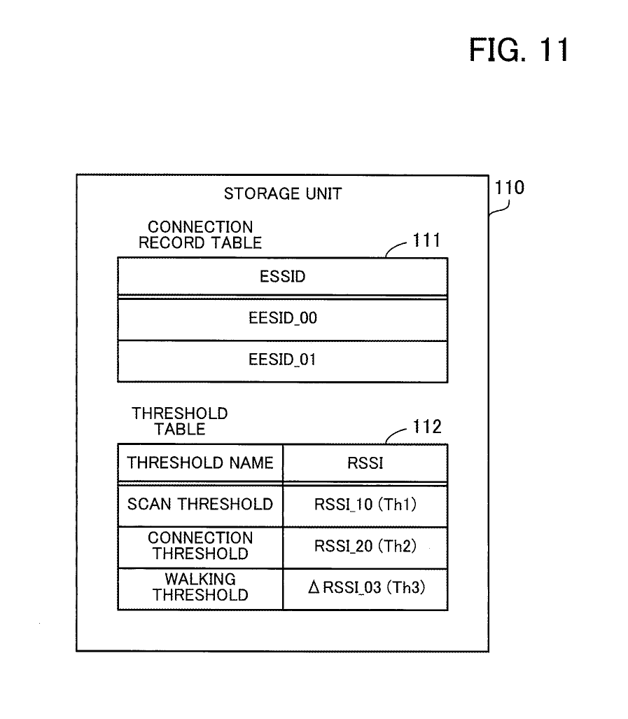

FIG. 11 illustrates an example of the connection record table 111 and the threshold table 112.

The storage unit 110 stores the connection record table 111 and the threshold table 112.

The connection record table 111 includes a list of ESSIDs. The ESSIDs registered in the connection record table 111 include the ESSID of an access point to which the mobile communication apparatus 100 has previously connected in response to an instruction from the user. The mobile communication apparatus 100 is able to automatically connect to an access point having the same ESSID as the access point that has previously been selected by the user, even without an explicit instruction from the user. In the example of FIG. 11, “ESSID_00” and “ESSID_01” are registered in the connection record table 111.

Note that the BSSID of a previously connected access point may be stored in the connection record table 111 instead of or together with the ESSID. In this case, the mobile communication apparatus 100 may allow automatic connection only to an access point having the same BSSID as (that is, an access point physically identical to) a previously selected access point.

The threshold table 112 includes a list of pairs of a threshold name and an RSSI as its value. The thresholds include a scan threshold, a connection threshold, and a walking threshold. The scan threshold corresponds to the threshold Th1 of FIG. 5, and is a threshold for determining whether to perform a capture scan. The connection threshold corresponds to the threshold Th2 of FIG. 5, and is a threshold for determining whether to connect to a detected access point. The connection threshold has a value greater than the scan threshold. The walking threshold is a threshold to be referred to when estimating the walking status of the user, without using the walking sensor 108. If the amount of change in RSSI from the previous scan is greater than the walking threshold, it is estimated that the user is walking.

In the example of FIG. 11, “RSSI_10” (Th1) as a scan threshold, “RSSI_20” (Th2) as a connection threshold, and “ΔRSSI_03” (Th3) as a walking threshold are registered in the threshold table 112. Note that in the following description, the two-digit number of an RSSI is proportional to the RSSI, and increases as the RSSI increases. Accordingly, the magnitude relationship between the scan threshold and the connection threshold is RSSI_10<RSSI_20.

The following describes scan control corresponding to the above termination conditions #1, #3, #5, and #6.

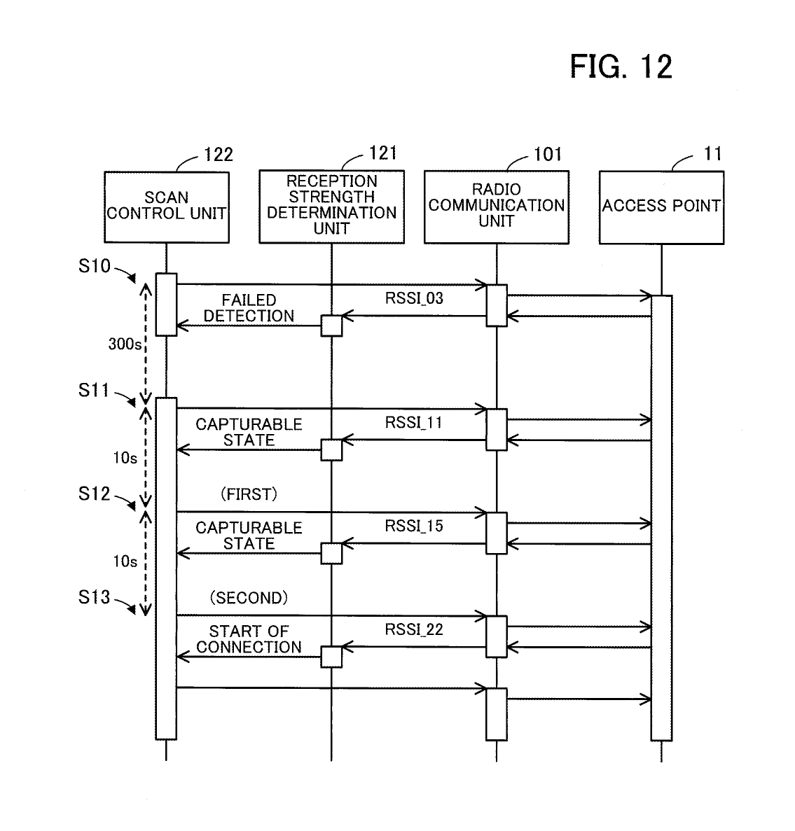

FIG. 12 is a sequence diagram illustrating an example of first capture scan control.

The first capture scan control corresponds to the termination condition #1.

(S10) The scan control unit 122 instructs the radio communication unit 101 to perform a normal scan. The radio communication unit 101 executes a normal scan as illustrated in FIG. 9. It is assumed here that the access point 11 uses a channel of the 2.4 GHz band for radio communication. The radio communication unit 101 transmits a probe request not specifying an ESSID (broadcast). The access point 11 returns a probe response including an ESSID to the radio communication unit 101.

The radio communication unit 101 measures the RSSI for the probe response received from the access point 11, and reports the ESSID and RSSI to the reception strength determination unit 121. In this step, the measured RSSI is RSSI_03. Since RSSI_03≦the scan threshold (RSSI_10), the reception strength determination unit 121 notifies the scan control unit 122 of a failed detection. The scan control unit 122 waits 300 seconds for the next normal scan to be performed. Note that the scan threshold may be stored in the radio communication unit 101 such that when the RSSI is less than or equal to the scan threshold, the scan control unit 122 is not notified of a failed detection.

(S11) The radio communication unit 101 performs a normal scan in the same manner as in step S10. In this step, the measured RSSI is RSSI_11. Further, the ESSID of the access point 11 is ESSID_00. Since RSSI_11>the scan threshold; ESSID_00 is of a previously connected access point; and RSSI_11 the connection threshold (RSSI_20); the reception strength determination unit 121 notifies the scan control unit 122 of a capturable state. The scan control unit 122 waits 10 seconds for a capture scan to be performed.

(S12) The scan control unit 122 instructs the radio communication unit 101 to perform the first capture scan. At this point, for example, the scan control unit 122 specifies ESSID_00. The radio communication unit 101 transmits a probe request specifying ESSID_00 (unicast). The access point 11 returns a probe response to the radio communication unit 101. In this step, the measured RSSI is RSSI_15. Since RSSI_15>the scan threshold, and since RSSI_15≦the connection threshold, the reception strength determination unit 121 notifies the scan control unit 122 of a capturable state. The scan control unit 122 waits for 10 seconds.

(S13) The radio communication unit 101 performs the second capture scan in the same manner as in step S12. In this step, the measured RSSI is RSSI_22. Since RSSI_22>the connection threshold, the reception strength determination unit 121 notifies the scan control unit 122 of the start of a connection. The scan control unit 122 starts a connection procedure, and instructs the radio communication unit 101 to connect to the access point 11. The radio communication unit 101 transmits a connection request to the access point 11, and establishes a connection to the access point 11.

In the above description, the radio communication unit 101 acquires the ESSID and RSSI of the access point 11 by an active scan. However, the radio communication unit 101 may acquire the ESSID and RSSI by a passive scan. For example, the radio communication unit 101 receives a beacon periodically transmitted from the access point 11. The radio communication unit 101 measures the RSSI for the received beacon, and extracts an ESSID included in the beacon.

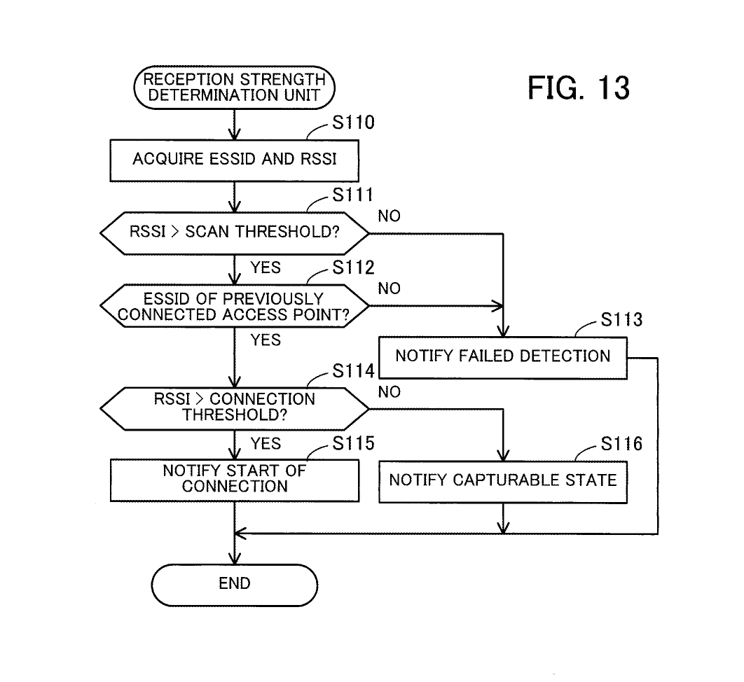

FIG. 13 is a flowchart illustrating an example of a first process performed by the reception strength determination unit 121.

The operations in steps S110 through S116 described below are executed by the reception strength determination unit 121 each time the radio communication unit 101 performs a scan (a normal scan or a capture scan).

(S110) The reception strength determination unit 121 acquires an ESSID and an RSSI.

(S111) The reception strength determination unit 121 refers to the threshold table 112 to determine whether the RSSI acquired in step S110 is greater than the scan threshold. If the acquired RSSI is greater than the scan threshold, the process proceeds to step S112. If the acquired RSSI is less than or equal to the scan threshold, the process proceeds to step S113.

(S112) The reception strength determination unit 121 determines whether the ESSID acquired in step S110 is registered in the connection record table 111, that is, whether the ESSID is of an access point to which the mobile communication apparatus 100 has previously connected. If the ESSID is of a previously connected access point, the process proceeds to step S114. If the ESSID is not of a previously connected access point, the process proceeds to step S113.

(S113) The reception strength determination unit 121 notifies the scan control unit 122 of a failed detection. Then, the process by the reception strength determination unit 121 for the current scan ends.

(S114) The reception strength determination unit 121 refers to the threshold table 112 to determine whether the RSSI acquired in step S110 is greater than the connection threshold. If the acquired RSSI is greater than the connection threshold, the process proceeds to step S115. If the acquired RSSI is less than or equal to the connection threshold, the process proceeds to step S116.

(S115) The reception strength determination unit 121 notifies the scan control unit 122 of the start of a connection. Then, the process by the reception strength determination unit 121 for the current scan ends.

(S116) The reception strength determination unit 121 notifies the scan control unit 122 of a capturable state.

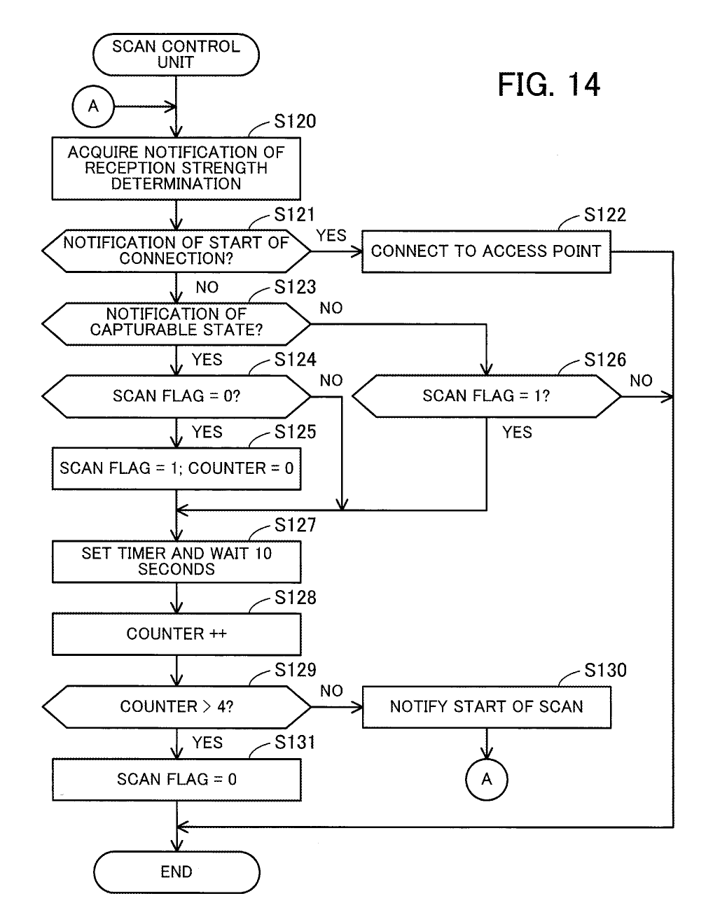

FIG. 14 is a flowchart illustrating an example of a first process performed by the scan control unit 122.

The operations in steps S120 through S131 described below are executed by the scan control unit 122 each time the radio communication unit 101 performs a normal scan.

(S120) The scan control unit 122 obtains a notification from the reception strength determination unit 121. The notification that may be obtained includes a notification of the start of a connection, a notification of a capturable state, and a notification of a failed detection.

(S121) The scan control unit 122 determines whether the notification obtained in step S120 indicates the start of a connection. If the notification indicates the start of a connection, the process proceeds to step S122. If the notification indicates another event (a capturable state or a failed detection), the process proceeds to step S123.

(S122) The scan control unit 122 instructs the radio communication unit 101 to connect to the detected access point. Then, the process by the scan control unit 122 ends.

(S123) The scan control unit 122 determines whether the notification obtained in step S120 indicates a capturable state. If the notification indicates a capturable state, the process proceeds to step S124. If the notification indicates another event (a failed detection), the process proceeds to step S126.

(S124) The scan control unit 122 determines whether the scan flag=0. When the scan flag=0, it indicates that the fourth capture scan has not started. If the scan flag=0, the process proceeds to step S125. If not, the process proceeds to step S127.

(S125) The scan control unit 122 updates the scan flag to 1. Further, the scan control unit 122 initializes the counter to 0. The counter indicates the number of times a capture scan is performed. Then, the process proceeds to step S127.

(S126) The scan control unit 122 determines whether the scan flag=1. When the scan flag=1, it indicates that the fourth capture scan has started. If the scan flag=1, the process proceeds to step S127. If not, the process by the scan control unit 122 ends. Note that the path from step S126 to step S127 indicates that a capture scan is repeated up to four times even when the detection of an access point fails in the first through third capture scans. This is because in the case where, for example, there is a person between the access point and the mobile communication apparatus 100, the RSSI may drop instantaneously due to a temporary change in the radio wave environment.

(S127) The scan control unit 122 sets the timer and waits for 10 seconds to elapse.

(S128) The scan control unit 122 increments the counter by 1.

(S129) The scan control unit 122 determines whether the counter updated in step S128 is greater than 4, that is, whether a capture scan has been executed four times. If the counter is greater than 4, the process proceeds to step S131. If the counter is less than or equal to 4, the process proceeds to step S130.

(S130) The scan control unit 122 notifies the radio communication unit 101 of the start of a scan. Thus, a capture scan is performed. Then, the process returns to step S120 such that the above operations are performed on the result of the capture scan.

(S131) The scan control unit 122 updates the scan flag to 0. Then, a series of operations following the current normal scan ends.

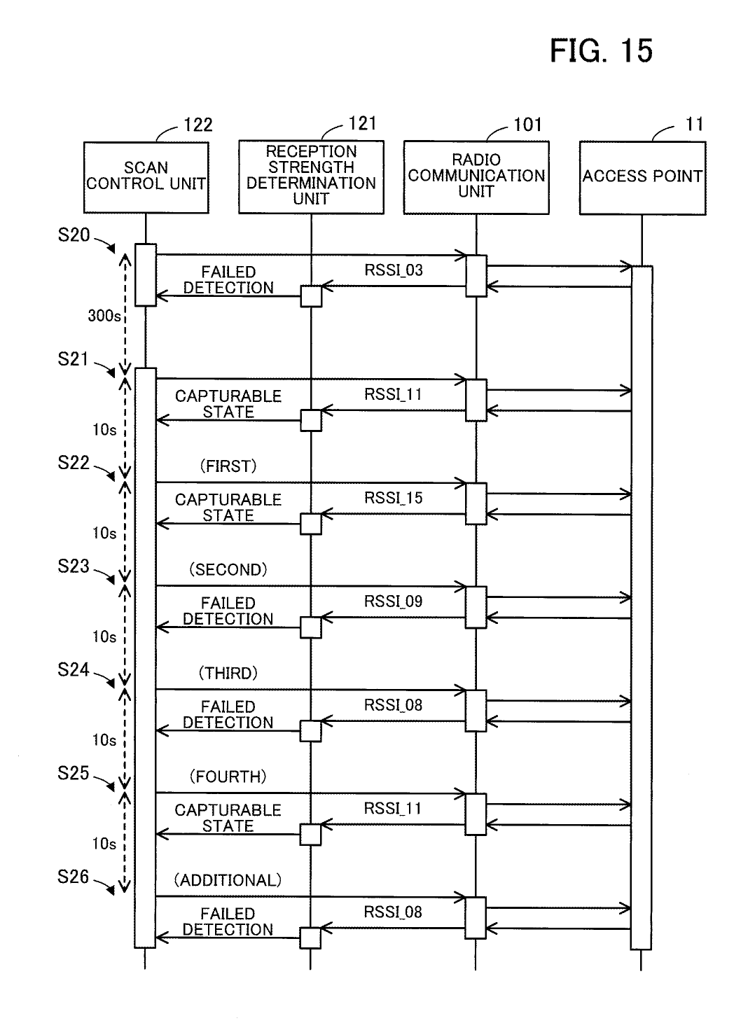

FIG. 15 is a sequence diagram illustrating an example of second capture scan control.

The second capture scan control corresponds to the termination condition #3.

(S20) The scan control unit 122 instructs the radio communication unit 101 to perform a normal scan. The radio communication unit 101 transmits a broadcast probe request, and receives a probe response from the access point 11. In this step, the measured RSSI is RSSI_03. Since RSSI_03≦the scan threshold, the reception strength determination unit 121 notifies the scan control unit 122 of a failed detection. The scan control unit 122 waits for 300 seconds.

(S21) The radio communication unit 101 performs a normal scan in the same manner as in step S20. In this step, the measured RSSI is RSSI_11. Since RSSI_11>the scan threshold, and since RSSI_11 the connection threshold, the reception strength determination unit 121 notifies the scan control unit 122 of a capturable state. The scan control unit 122 waits for 10 seconds.

(S22) The scan control unit 122 instructs the radio communication unit 101 to perform the first capture scan. The radio communication unit 101 transmits a unicast probe request, and receives a probe response from the access point 11. In this step, the measured RSSI is RSSI_15. Since RSSI_15>the scan threshold, and since RSSI_15 the connection threshold, the reception strength determination unit 121 notifies the scan control unit 122 of a capturable state.

(S23) The radio communication unit 101 performs the second capture scan in the same manner as in step S22. In this step, the measured RSSI is RSSI_09. Since RSSI_09≦the scan threshold, the reception strength determination unit 121 notifies the scan control unit 122 of a failed detection. However, the capture scan is repeated up to four times.

(S24) The radio communication unit 101 performs the third capture scan in the same manner as in step S22. In this step, the measured RSSI is RSSI_08. Since RSSI_08≦the scan threshold, the reception strength determination unit 121 notifies the scan control unit 122 of a failed detection. However, the capture scan is repeated up to four times.

(S25) The radio communication unit 101 performs the fourth capture scan in the same manner as in step S22. In this step, the measured RSSI is RSSI_11. Since RSSI_11>the scan threshold, and since RSSI_11≦the connection threshold, the reception strength determination unit 121 notifies the scan control unit 122 of a capturable state. If a capturable state is determined in the fourth capture scan, an additional capture scan is repeatedly performed until a connection becomes possible or until the detection fails.

(S26) The radio communication unit 101 performs an additional capture scan in the same manner as in step S22. In this step, the measured RSSI is RSSI_08. Since RSSI_08≦the scan threshold, the reception strength determination unit 121 notifies the scan control unit 122 of a failed detection. Thus, the capture scan ends.

The process performed by the reception strength determination unit 121 in the second capture scan control is the same as that in the first capture scan control of FIG. 13, and will not be described herein.

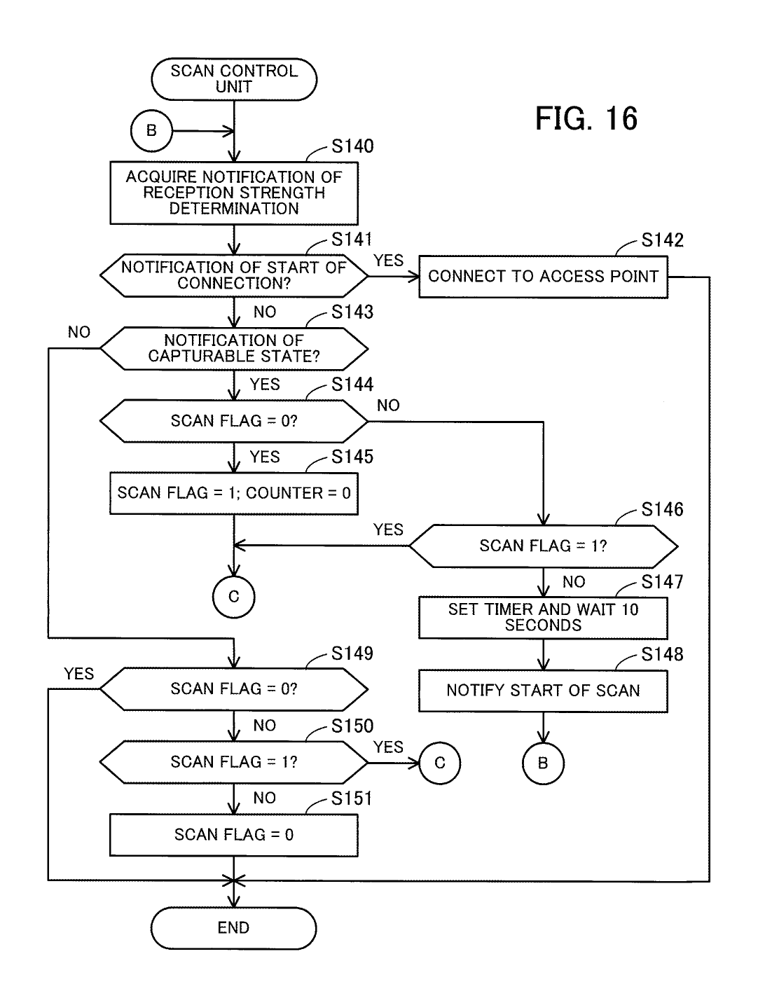

FIG. 16 is a flowchart illustrating an example of a second process performed by the scan control unit 122.

(S140) The scan control unit 122 obtains a notification from the reception strength determination unit 121.

(S141) The scan control unit 122 determines whether the notification indicates the start of a connection. If the notification indicates the start of a connection, the process proceeds to step S142. If not, the process proceeds to step S143.

(S142) The scan control unit 122 instructs the radio communication unit 101 to connect to the detected access point. Then, the process by the scan control unit 122 ends.

(S143) The scan control unit 122 determines whether the notification indicates a capturable state. If the notification indicates a capturable state, the process proceeds to step S144. If not, the process proceeds to step S149.

(S144) The scan control unit 122 determines whether the scan flag=0. If the scan flag=0, the process proceeds to step S145. If not, the process proceeds to step S146.

(S145) The scan control unit 122 updates the scan flag to 1, and initializes the counter to 0. Then, the process proceeds to step S152.

(S146) The scan control unit 122 determines whether the scan flag=1. If the scan flag=1, the process proceeds to step S152. If not, the process proceeds to step S147. Note that the path from step S146 to S147 is taken when the scan flag=2. When the scan flag=2, it indicates that the radio communication unit 101 has executed a capture scan four times, and then has performed an additional capture scan.

(S147) The scan control unit 122 sets the timer and waits for 10 seconds to elapse.

(S148) The scan control unit 122 notifies the radio communication unit 101 of the start of a scan. Thus, an additional capture scan is performed. Then, the process returns to step S140 such that the above operations are performed on the result of the additional capture scan.

(S149) The scan control unit 122 determines whether the scan flag=0. If scan flag=0, a series of operations following the current normal scan ends without performing a capture scan. If not, the process proceeds to step S150.

(S150) The scan control unit 122 determines whether the scan flag=1. If the scan flag=1, the process proceeds to step S152. If not, the process proceeds to step S151.

(S151) The scan control unit 122 updates the scan flag to 0. Then, the additional capture scan ends, and a series of operations following the current normal scan ends.

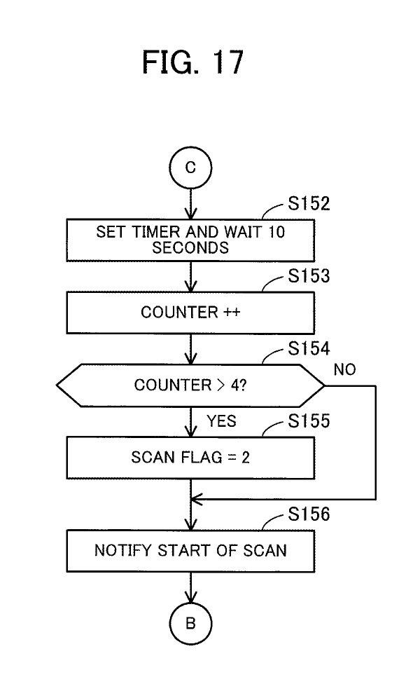

FIG. 17 is a flowchart (continued from FIG. 16) illustrating the second example of a process performed by the scan control unit 122.

(S152) The scan control unit 122 sets the timer and waits for 10 seconds to elapse.

(S153) The scan control unit 122 increments the counter by 1.

(S154) The scan control unit 122 determines whether the counter is greater than 4. If the counter is greater than 4, the process proceeds to step S155. If not, the process proceeds to step S156.

(S155) The scan control unit 122 updates the scan flag to 2.

(S156) The scan control unit 122 notifies the radio communication unit 101 of the start of a scan. Thus, a capture scan (including an additional capture scan) is performed. Then, the process returns to step S140 such that the above operations are performed on the result of the capture scan.

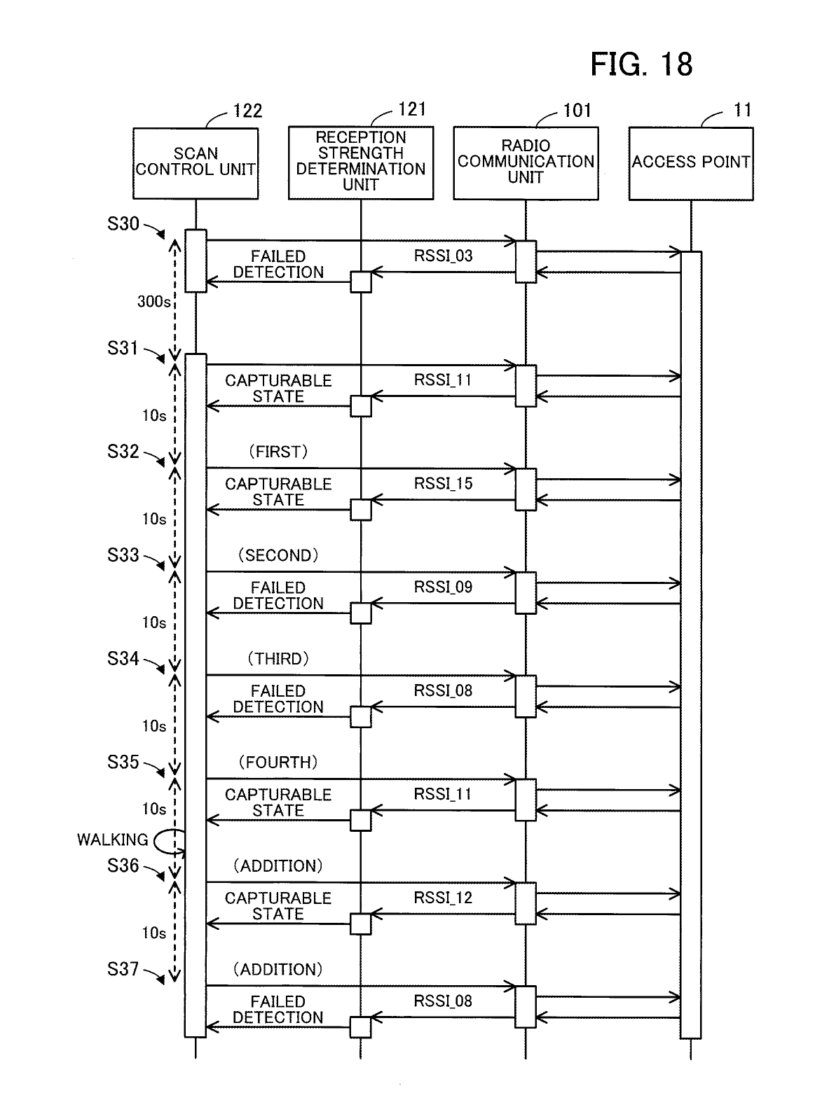

FIG. 18 is a sequence diagram illustrating an example of third capture scan control.

The third capture scan control corresponds to the termination condition #5. The operations in steps S30 through S34 of FIG. 18 are the same as the operations in steps S20 through S24 of FIG. 15, and will not be descried herein.

(S35) The scan control unit 122 instructs the radio communication unit 101 to perform the fourth capture scan. The radio communication unit 101 transmits a unicast probe request, and receives a probe response from the access point 11. In this step, the measured RSSI is RSSI_11. Since RSSI_11>the scan threshold, and since RSSI_11≦the connection threshold, the reception strength determination unit 121 notifies the scan control unit 122 of a capturable state.

The scan control unit 122 acquires walking information generated by the walking sensor 108 from the walking information acquisition unit 124, and determines whether the user is walking or stationary. It is assumed here that the user is walking. Then, the scan control unit 122 determines to add a capture scan. An additional capture scan is repeated until a connection becomes possible or until the detection fails.

(S36) The radio communication unit 101 performs an additional capture scan in the same manner as in step S35. In this step, the measured RSSI is RSSI_12. Since RSSI_12>the scan threshold, and since RSSI_12≦the connection threshold, the reception strength determination unit 121 notifies the scan control unit 122 of a capturable state. The scan control unit 122 waits for 10 seconds.

(S37) The radio communication unit 101 performs an additional capture scan in the same manner as in step S35. In this step, the measured RSSI is RSSI_08. Since RSSI_08≦the scan threshold, the reception strength determination unit 121 notifies the scan control unit 122 of a failed detection. Thus, the capture scan ends.

The process performed by the reception strength determination unit 121 in the third capture scan control is the same as that in the first capture scan control of FIG. 13, and will not be described herein. Further, the process performed by the scan control unit 122 in the third capture scan control is the same as that in the second capture scan in the part illustrated in FIG. 16, and is different from that in the second scan control in the part illustrated in FIG. 17.

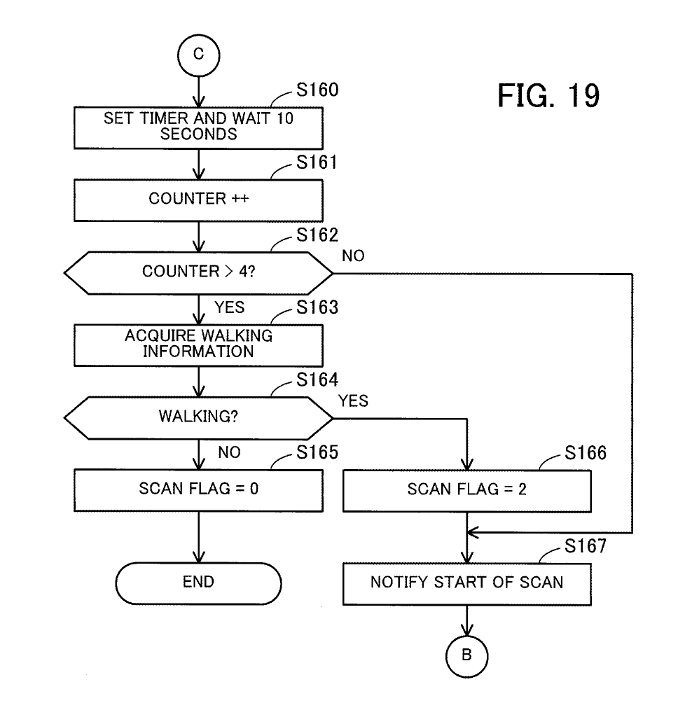

FIG. 19 is a flowchart illustrating an example of a part of a third process performed by the scan control unit 122.

(S160) After the above described step S145, step S146, or step S150, the scan control unit 122 sets the timer and waits for 10 seconds to elapse.

(S161) The scan control unit 122 increments the counter by 1.

(S162) The scan control unit 122 determines whether the counter is greater than 4. If the counter is greater than 4, the process proceeds to step S163. If not, the process proceeds to step S167.

(S163) The scan control unit 122 acquires walking information generated by the walking sensor 108 from the walking information acquisition unit 124. The walking information includes information indicating whether the user is walking or stationary.

(S164) The scan control unit 122 determines whether the walking information acquired in step S163 indicates that the user is walking. If the user is walking, the process proceeds to step S166. If the user is stationary, the process proceeds to step S165.

(S165) The scan control unit 122 updates the scan flag to 0. Then, a series of operations following the current normal scan ends without performing an additional capture scan.

(S166) The scan control unit 122 updates the scan flag to 2.

(S167) The scan control unit 122 notifies the radio communication unit 101 of the start of a scan. Thus, a capture scan (including an additional capture scan) is performed. Then, the process returns to step S140 such that the above operations are performed on the result of the capture scan.

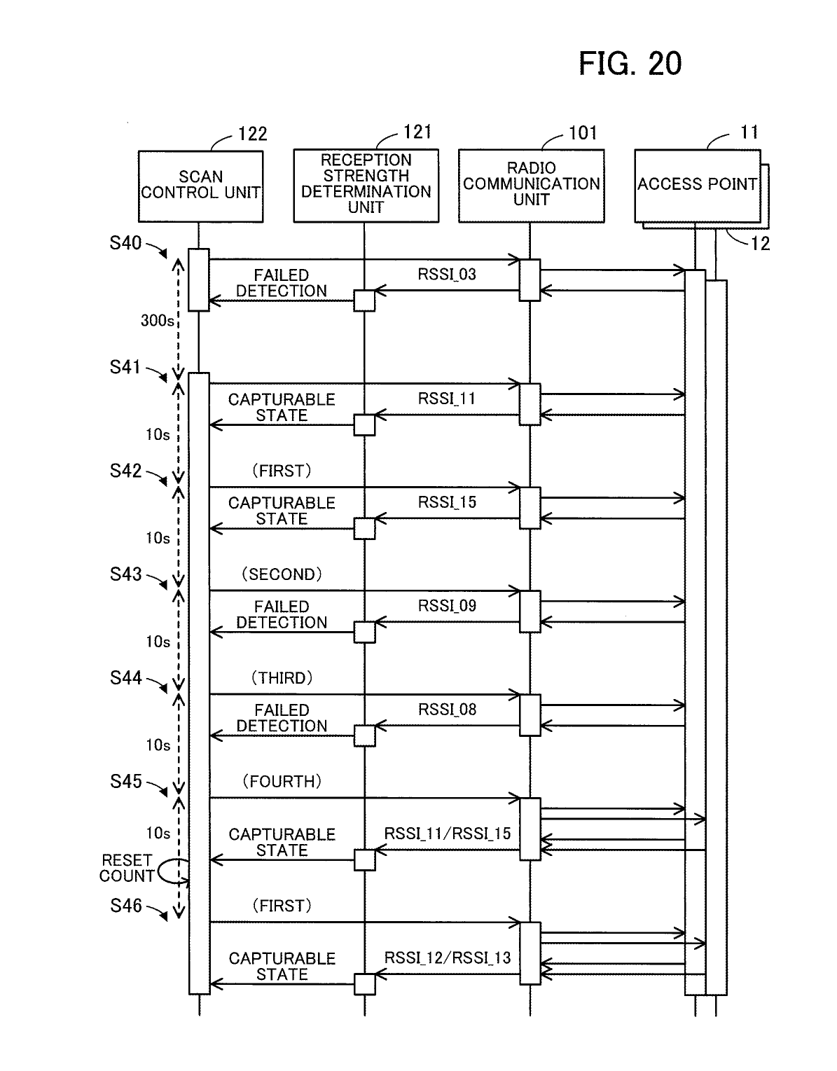

FIG. 20 is a sequence diagram illustrating an example of fourth capture scan control.

The fourth capture scan control corresponds to the termination condition #6.

(S40) The scan control unit 122 instructs the radio communication unit 101 to perform a normal scan. The radio communication unit 101 transmits a broadcast probe request, and receives a probe response from the access point 11. The radio communication unit 101 measures the RSSI, and reports the ESSID, BSSID, and RSSI to the reception strength determination unit 121. In this step, the RSSI of the access point 11 is RSSI_03. Since RSSI_03≦the scan threshold, the reception strength determination unit 121 notifies the scan control unit 122 of a failed detection.

(S41) The radio communication unit 101 performs a normal scan in the same manner as in step S40. In this step, the RSSI of the access point 11 is RSSI_11. Since RSSI_11>the scan threshold, and since RSSI_11≦the connection threshold, the reception strength determination unit 121 notifies the scan control unit 122 of a capturable state. Further, the reception strength determination unit 121 reports the BSSID of the detected access point 11 to the scan control unit 122.

(S42) The scan control unit 122 instructs the radio communication unit 101 to perform the first capture scan. The radio communication unit 101 transmits a unicast probe request, and receives a probe response from the access point 11. In this step, the RSSI of the access point 11 is RSSI_15. Since RSSI_15>the scan threshold, and since RSSI_15≦the connection threshold, the reception strength determination unit 121 notifies the scan control unit 122 of a capturable state, and reports the BSSID of the detected access point 11 to the scan control unit 122.

(S43) The radio communication unit 101 performs the second capture scan in the same manner as in step S42.

In this step, the RSSI of the access point 11 is RSSI_09. Since RSSI_09≦the scan threshold, the reception strength determination unit 121 notifies the scan control unit 122 of a failed detection. However, the capture scan is repeated up to four times.

(S44) The radio communication unit 101 performs the third capture scan in the same manner as in step S42. In this step, the measured RSSI is RSSI_08. Since RSSI_08≦the scan threshold, the reception strength determination unit 121 notifies the scan control unit 122 of a failed detection. However, the capture scan is repeated up to four times.

(S45) The scan control unit 122 instructs the radio communication unit 101 to perform the fourth capture scan. The radio communication unit 101 transmits a unicast probe request. It is assumed here that the probe request reaches the access point 12 in addition to the access point 11. The access point 12 has the same ESSID as the access point 11. Thus, the radio communication unit 101 receives a probe response from each of the access points 11 and 12.

The radio communication unit 101 measures the RSSI for each probe response, and reports the ESSID, BSSID, and RSSI of each access point to the reception strength determination unit 121. In this step, the RSSI of the access point 11 is RSSI_11, and the RSSI of the access point 12 is RSSI_15. That is, RSSI_11>the scan threshold, and RSSI_15>the scan threshold. Further, RSSI_11≦the connection threshold, and RSSI_15≦the connection threshold. Therefore, the reception strength determination unit 121 notifies the scan control unit 122 of a capturable state. Further, the reception strength determination unit 121 reports the BSSIDs of the detected access points 11 and 12 to the scan control unit 122.

The scan control unit 122 founds that a new access point that was not detected in the previous scan is detected, that is, a new BSSID is reported from the reception strength determination unit 121. Then, the scan control unit 122 resets the count of capture scans.

(S46) The scan control unit 122 instructs the radio communication unit 101 to perform a capture scan. This capture scan is regarded as the first capture scan. The radio communication unit 101 transmits a unicast probe request, and receives a probe response from each of the access points 11 and 12. In this step, the RSSI of the access point 11 is RSSI_12, and the RSSI of the access point 12 is RSSI_13. That is, RSSI_12>the scan threshold, and RSSI_13>the scan threshold. Further, RSSI_12≦the connection threshold, and RSSI_13≦the connection threshold. Therefore, the reception strength determination unit 121 notifies the scan control unit 122 of a capturable state. Further, the reception strength determination unit 121 reports the BSSIDs of the detected access points 11 and 12 to the scan control unit 122.

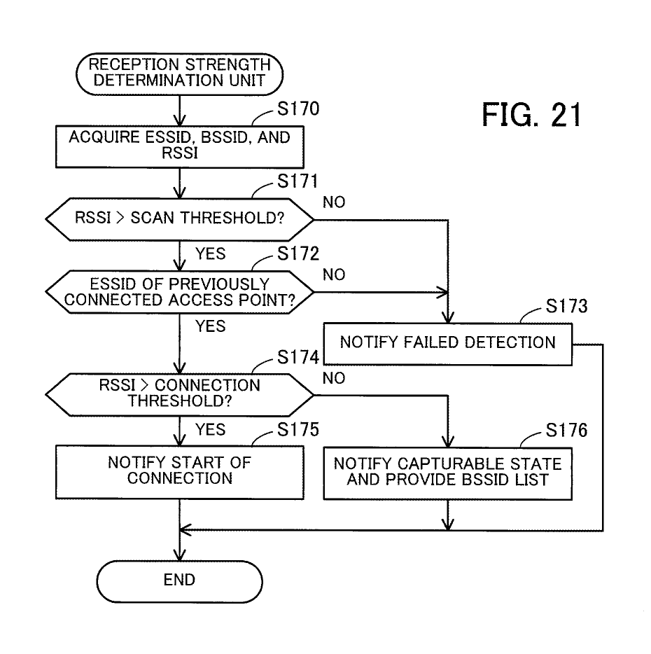

FIG. 21 is a flowchart illustrating an example of a fourth process performed by the reception strength determination unit 121.

(S170) The reception strength determination unit 121 acquires the ESSID, BSSID, and RSSI of each of detected access points.

(S171) The reception strength determination unit 121 determines whether any of the detected access points has an RSSI greater than the scan threshold. If any of the access points has an RSSI greater than the scan threshold, the process proceeds to step S172. If the RSSIs of all the access points are less than or equal to the scan threshold, the process proceeds to step S173.

(S172) The reception strength determination unit 121 determines whether any of the access points found in step S171 has an ESSID of a previously connected access point. If any of the access points has an ESSID of a previously connected access point, the process proceeds to step S174. If there is no access point having an ESSID of a previously connected access point, the process proceeds to step S173.

(S173) The reception strength determination unit 121 notifies the scan control unit 122 of a failed detection. Then, the process by the reception strength determination unit 121 for the current scan ends.

(S174) The reception strength determination unit 121 determines whether any of the access points found in Steps S171 and S172 has an RSSI greater than the connection threshold. If any of the access points has an RSSI greater than the connection threshold, the process proceeds to step S175. If the RSSIs of all the access points are less than or equal to the connection threshold, the process proceeds to step S176.

(S175) The reception strength determination unit 121 notifies the scan control unit 122 of the start of a connection. Then, the process by the reception strength determination unit 121 for the current scan ends.

(S176) The reception strength determination unit 121 notifies the scan control unit 122 of a capturable state. Further, the reception strength determination unit 121 provides a BSSID list including BSSIDs of the access points found in steps S171 and S172 to the scan control unit 122.

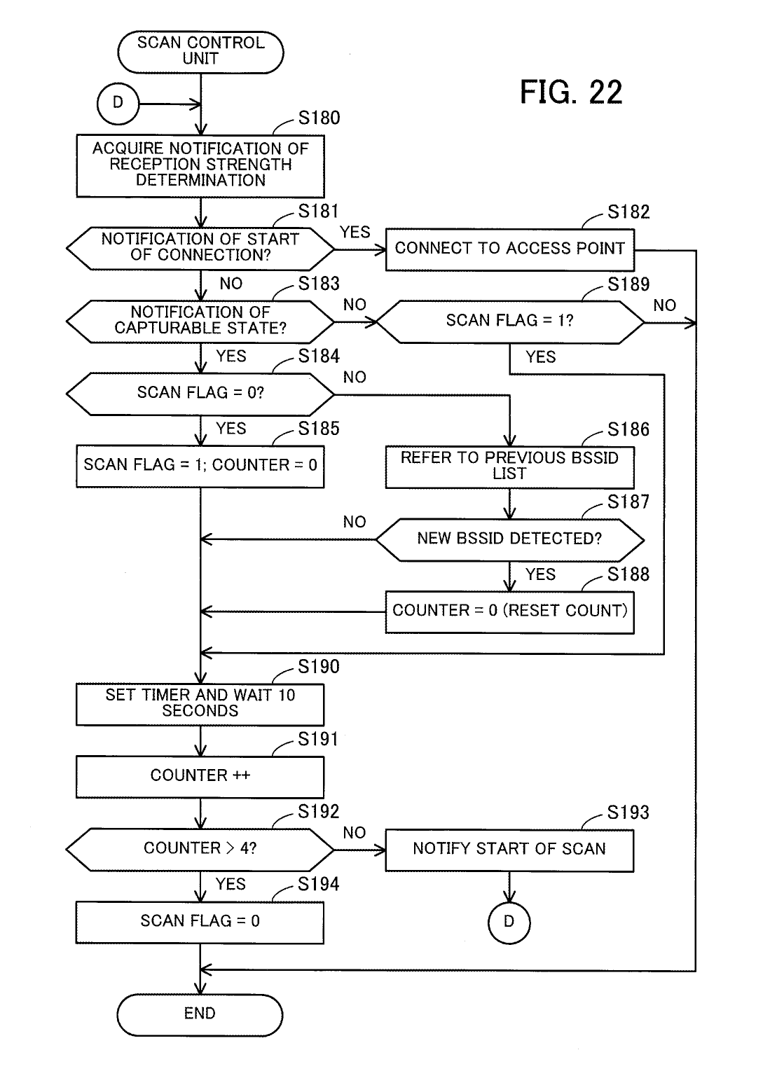

FIG. 22 is a flowchart illustrating an example of a fourth process performed by the scan control unit 122.

(S180) The scan control unit 122 obtains a notification from the reception strength determination unit 121.

(S181) The scan control unit 122 determines whether the notification indicates the start of a connection. If the notification indicates the start of a connection, the process proceeds to step S182. If not, the process proceeds to step S183.

(S182) The scan control unit 122 instructs the radio communication unit 101 to connect to the detected access point. Then, the process by the scan control unit 122 ends.

(S183) The scan control unit 122 determines whether the notification indicates a capturable state. If the notification indicates a capturable state, the process proceeds to step S184. If not, the process proceeds to step S189. Note that if the notification indicates a capturable state, the scan control unit 122 acquires a BSSID list from the reception strength determination unit 121, and retains the BSSID list until the next scan.

(S184) The scan control unit 122 determines whether the scan flag=0. If the scan flag=0, the process proceeds to step S185. If not, the process proceeds to step S186.

(S185) The scan control unit 122 updates the scan flag to 1, and initializes the counter to 0. Then, the process proceeds to step S190.

(S186) The scan control unit 122 reads the BSSID list acquired in the immediately preceding scan (a normal scan or a capture scan).

(S187) The scan control unit 122 compares the BSSID list for the current capture scan with the BSSID list read in step S186, and determines whether a new BSSID (a new access point) is detected. If a new BSSID is detected, the process proceeds to step S188. If not, the process proceeds to step S190.

(S188) The scan control unit 122 initializes the counter to 0 (that is, resets the count of capture scans). Then, the process proceeds to step S190.

(S189) The scan control unit 122 determines whether the scan flag=1. If the scan flag=1, the process proceeds to step S190. If not, the process ends.

(S190) The scan control unit 122 sets the timer and waits for 10 seconds to elapse.

(S191) The scan control unit 122 increments the counter by 1.

(S192) The scan control unit 122 determines whether the counter is greater than 4. If the counter is greater than 4, the process proceeds to step S194. If not, the process proceeds to step S193.

(S193) The scan control unit 122 notifies the radio communication unit 101 of the start of a scan. Thus, a capture scan is performed. Then, the process proceeds to step S180.

(S194) The scan control unit 122 updates the scan flag to 0.

According to the mobile communication system of the second embodiment, when an RSSI measured in a normal scan is less than or equal to a connection threshold and greater than a scan threshold, the interval to the next scan is reduced. For example, a capture scan is performed a plurality of times at short intervals after the current normal scan. In this way, even in the case where the interval between normal scans is long in order to reduce power consumption, when the RSSI is likely to exceed the connection threshold soon, the frequency of scanning is increased.

Accordingly, when the RSSI exceeds the connection threshold (when a connection becomes possible), it is possible to quickly connect to the access point without waiting for a long time, and to benefit from radio communication using the wireless LAN 10 early. For example, since it is possible to start using the wireless LAN 10 early, it is possible to improve the transmission speed, and to reduce the power consumption of the mobile communication apparatus 100. Further, since a capture scan is performed only on a channel whose RSSI is likely to exceed the connection threshold soon, it is possible to reduce power consumption.

### (c) Third Embodiment

Next, a description will be given of a third embodiment. The following mainly discusses the differences from the second embodiment. The same features as those of the second embodiment will not be described herein. A mobile communication system of the third embodiment is different from that of the second embodiment in the process of determining whether to reduce the scan interval (for example, whether to perform a capture scan after a normal scan).

The mobile communication system of the third embodiment may be implemented with the same system configuration as the mobile communication system of the second embodiment illustrated in FIG. 2. Further, the mobile communication apparatus 100 of the third embodiment may be implemented with the same configuration as the mobile communication apparatus 100 of the second embodiment illustrated in FIGS. 3 and 10. In the following, the third embodiment will be described using the same reference numbers as those used in FIGS. 2, 3, and 10.

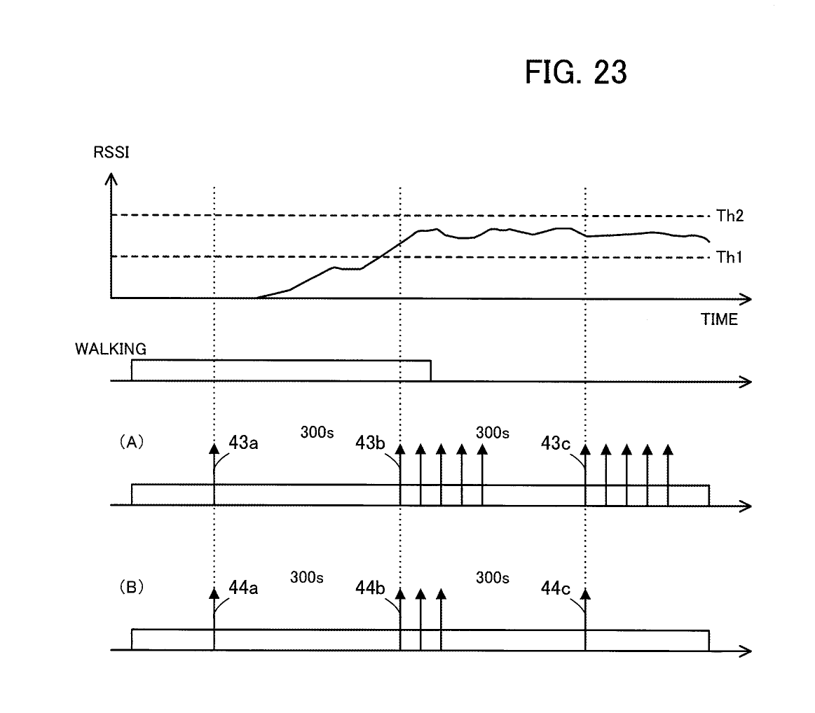

FIG. 23 illustrates another example of reducing the scan interval of the wireless LAN 10.

The following describes the case where the user carrying the mobile communication apparatus 100 walks from the outside of the radio area of the access point 11 toward the access point 11, and then stops in front of the radio area of the access point 11. As the user walks, the RSSI measured by the mobile communication apparatus 100 gradually increases and exceeds the threshold Th1 (scan threshold). However, when the user stops walking, the change in RSSI is reduced. Thus, the RSSI does not exceed the threshold Th2 (connection threshold).

In the case on not taking into consideration the fact that the user has stopped walking, the mobile communication apparatus 100 performs a normal scan 43a. In the normal scan 43a, the access point 11 is not detected yet. After 300 seconds, the mobile communication apparatus 100 performs a normal scan 43b. In the normal scan 43b, the RSSI of the access point 11 is less than or equal to the threshold Th2 and greater than the threshold Th1. Then, the mobile communication apparatus 100 performs a capture scan a plurality of times (for example, four times at 10-second intervals).

Even in the capture scan, the RSSI is not greater than the threshold Th2. Thus, the mobile communication apparatus 100 ends the capture scan, and performs a normal scan 43c after an interval (for example, after 300 seconds from the normal scan 43b). In the normal scan 43c, the RSSI of the access point 11 is less than or equal to the threshold Th2 and greater than the threshold Th1. Then, the mobile communication apparatus 100 performs a capture scan a plurality of times. However, even in the capture scans, the RSSI is not greater than the threshold Th2.

In this way, when the user is stationary in a location slightly outside the radio area of the access point 11, the RSSI measured by the mobile communication apparatus 100 might remain between the threshold Th2 and the threshold Th1. In this case, if the scan interval is controlled without taking into consideration the fact that the user has stopped walking, a capture scan is repeated for a long period of time, which might increase power consumption. In view of this, in the third embodiment, a determination as to whether to perform a capture scan is made taking into consideration whether the user has stopped walking.

In the case of taking into consideration whether the user has stopped walking, the mobile communication apparatus 100 performs a normal scan 44a in the same manner as the normal scan 43a. After 300 seconds, the mobile communication apparatus 100 performs a normal scan 44b in the same manner as the normal scan 43b. In the normal scan 44b, the RSSI of the access point 11 is less than or equal to the threshold Th2 and greater than the threshold Th1. Further, at this point, the user is walking. Then, the mobile communication apparatus 100 starts a capture scan. However, in any of capture scans before the final capture scan (for example, in the second capture scan), if the mobile communication apparatus 100 detects that the user is not walking, the mobile communication apparatus 100 does not perform subsequent capture scans.

Then, after an interval (for example, after 300 seconds from the normal scan 44b), the mobile communication apparatus 100 performs a normal scan 44c. In the normal scan 44c as well, the RSSI of the access point 11 is less than or equal to the threshold Th2 and greater than the threshold Th1. However, since the user is not walking, the mobile communication apparatus 100 does not perform a capture scan.

In the third embodiment, the walking status of the user is detected using the walking sensor 108. Note that in the above description, a capture scan is not performed when the user is stationary. However, neither a capture scan nor a normal scan may be performed when the user is stationary.

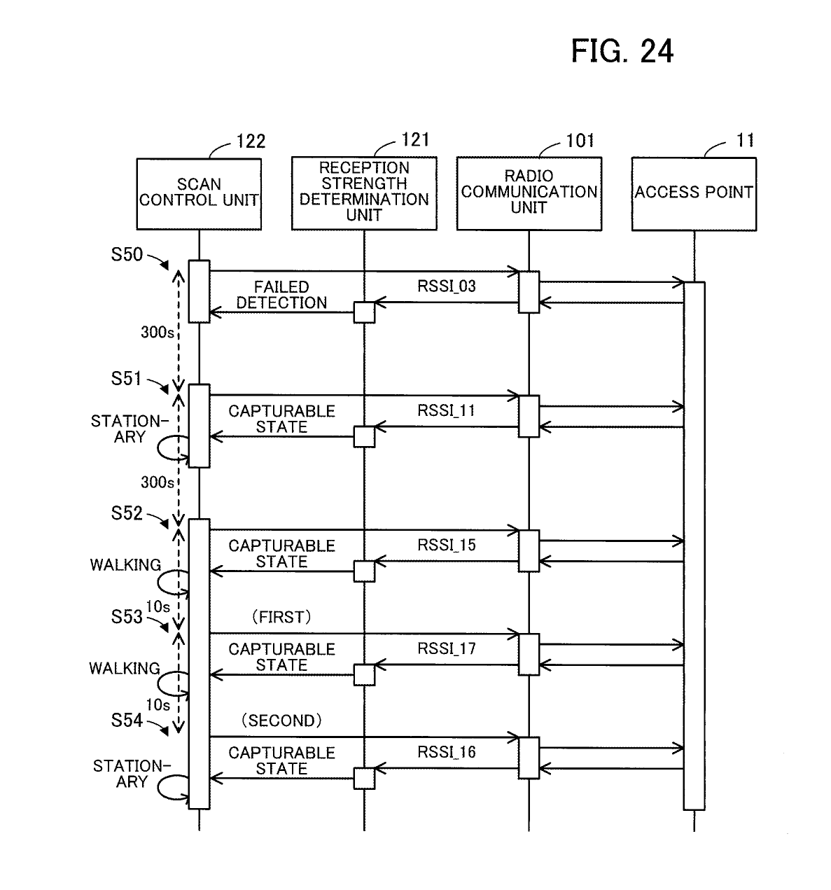

FIG. 24 is a sequence diagram illustrating an example of fifth capture scan control.

(S50) The scan control unit 122 instructs the radio communication unit 101 to perform a normal scan. The radio communication unit 101 transmits a broadcast probe request, and receives a probe response from the access point 11. In this step, the measured RSSI is RSSI_03. Since RSSI_03≦the scan threshold, the reception strength determination unit 121 notifies the scan control unit 122 of a failed detection. The scan control unit 122 waits for 300 seconds.

(S51) The radio communication unit 101 performs a normal scan in the same manner as in step S50. In this step, the measured RSSI is RSSI_11. Since RSSI_11>the scan threshold, and since RSSI_11≦the connection threshold, the reception strength determination unit 121 notifies the scan control unit 122 of a capturable state. The scan control unit 122 acquires walking information generated by the walking sensor 108 from the walking information acquisition unit 124, and determines whether the user is walking or stationary. It is assumed here that the user is stationary. Then, the scan control unit 122 determines not to perform a capture scan, and waits for 300 seconds.

(S52) The radio communication unit 101 performs a normal scan in the same manner as in step S50. In this step, the measured RSSI is RSSI_15. Since RSSI 15>the scan threshold, and since RSSI_15≦the connection threshold, the reception strength determination unit 121 notifies the scan control unit 122 of a capturable state. The scan control unit 122 acquires walking information generated by the walking sensor 108. It is assumed here that the user is walking. Then, the scan control unit 122 determines to perform a capture scan, and waits for 10 seconds.

(S53) The scan control unit 122 instructs the radio communication unit 101 to perform the first capture scan. The radio communication unit 101 transmits a unicast probe request, and receives a probe response from the access point 11. In this step, the measured RSSI is RSSI_17. Since RSSI_17>the scan threshold, and since RSSI_17≦the connection threshold, the reception strength determination unit 121 notifies the scan control unit 122 of a capturable state. The scan control unit 122 determines that the user is walking, and thus waits for 10 seconds.

(S54) The radio communication unit 101 performs the second capture scan in the same manner as in step S53. In this step, the measured RSSI is RSSI_16. Since RSSI_16>the scan threshold, and since RSSI_16≦the connection threshold, the reception strength determination unit 121 notifies the scan control unit 122 of a capturable state. The scan control unit 122 determines that the user is stationary, and thus determines not to perform subsequent capture scans.

The process performed by the reception strength determination unit 121 in the fifth capture scan control is the same as that in the first capture scan control of FIG. 13, and will not be described herein.

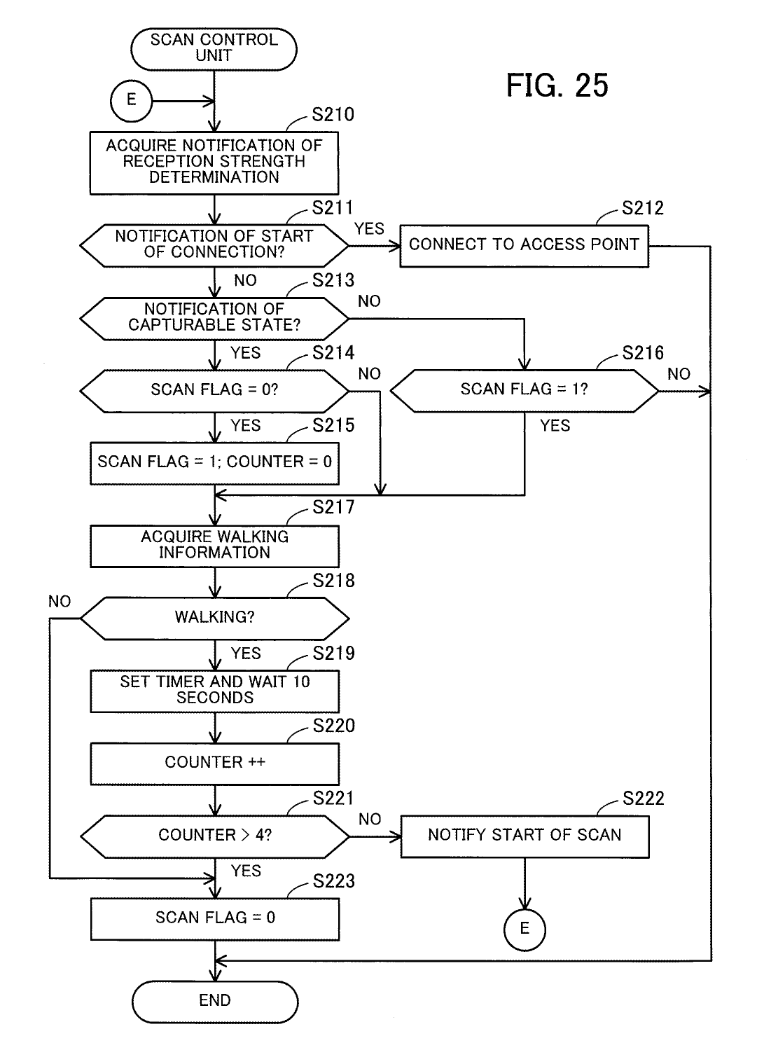

FIG. 25 is a flowchart illustrating an example of a fifth process performed by the scan control unit 122.

(S210) The scan control unit 122 obtains a notification from the reception strength determination unit 121.

(S211) The scan control unit 122 determines whether the notification indicates the start of a connection. If the notification indicates the start of a connection, the process proceeds to step S212. If not, the process proceeds to step S213.

(S212) The scan control unit 122 instructs the radio communication unit 101 to connect to the detected access point. Then, the process by the scan control unit 122 ends.

(S213) The scan control unit 122 determines whether the notification indicates a capturable state. If the notification indicates a capturable state, the process proceeds to step S214. If not, the process proceeds to step S216.

(S214) The scan control unit 122 determines whether the scan flag=0. If the scan flag=0, the process proceeds to step S215. If not, the process proceeds to step S217.

(S215) The scan control unit 122 updates the scan flag to 1, and initializes the counter to 0. Then, the process proceeds to step S217.

(S216) The scan control unit 122 determines whether the scan flag=1. If the scan flag=1, the process proceeds to step S217. If not, the process ends.

(S217) The scan control unit 122 acquires walking information generated by the walking sensor 108 from the walking information acquisition unit 124. The walking information includes information indicating whether the user is walking or stationary.

(S218) The scan control unit 122 determines whether the walking information acquired in step S217 indicates that the user is walking. If the user is walking, the process proceeds to step S219. If the user is stationary, the process proceeds to step S223.

(S219) The scan control unit 122 sets the timer and waits for 10 seconds to elapse.

(S220) The scan control unit 122 increments the counter by 1.

(S221) The scan control unit 122 determines whether the counter is greater than 4. If the counter is greater than 4, the process proceeds to step S223. If not, the process proceeds to step S222.

(S222) The scan control unit 122 notifies the radio communication unit 101 of the start of a scan. Thus, a capture scan is performed. Then, the process proceeds to step S210.

(S223) The scan control unit 122 updates the scan flag to 0.

According to the mobile communication system of the third embodiment, the same effects as those in the second embodiment are obtained. Further, according to the third embodiment, in the case where the user has stopped walking near the radio area of an access point and a connection to the access point is unlikely to become possible, it is possible to reduce the number of times a scan is performed, and thus to reduce the power consumption of the mobile communication apparatus 100.

### (d) Fourth Embodiment

Next, a description will be given of a fourth embodiment. The following mainly discusses the differences from the second and third embodiments. The same features as those of the second and third embodiments will not be described herein. A mobile communication system of the fourth embodiment estimates the walking status of the user, without using a walking sensor.

The mobile communication system of the fourth embodiment may be implemented with the same system configuration as the mobile communication system of the second embodiment illustrated in FIG. 2. Further, the mobile communication apparatus 100 of the fourth embodiment may be implemented with the same configuration as the mobile communication apparatus 100 of the second embodiment illustrated in FIGS. 3 and 10. In the following, the fourth embodiment will be described using the same reference numbers as those used in FIGS. 2, 3, and 10.

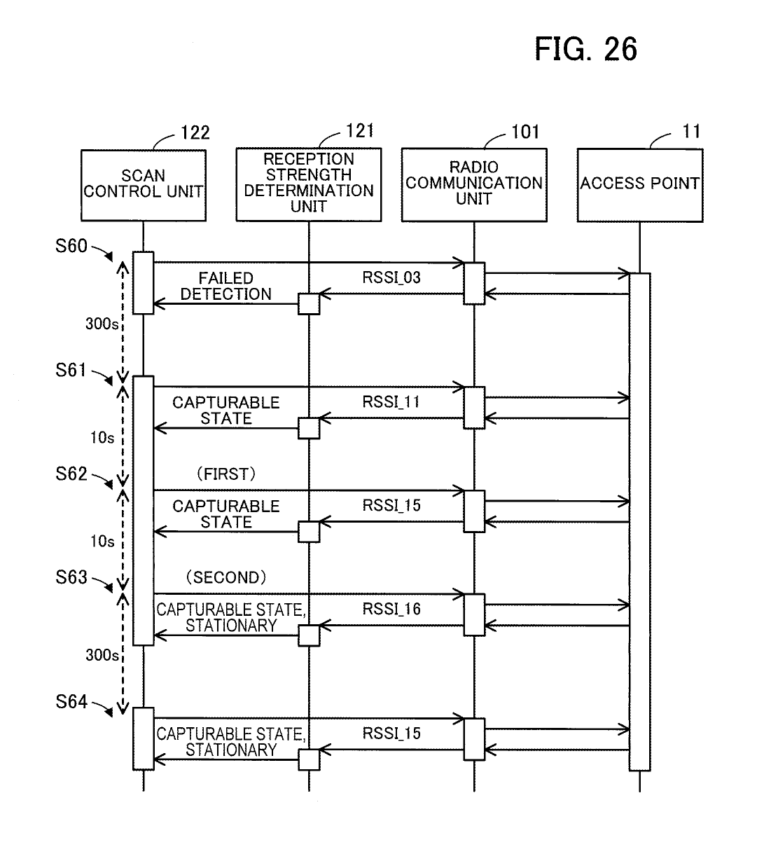

FIG. 26 is a sequence diagram illustrating an example of sixth capture scan control.

(S60) The scan control unit 122 instructs the radio communication unit 101 to perform a normal scan. The radio communication unit 101 transmits a broadcast probe request, and receives a probe response from the access point 11. In this step, the measured RSSI is RSSI_03. Since RSSI_03≦the scan threshold, the reception strength determination unit 121 notifies the scan control unit 122 of a failed detection. The scan control unit 122 waits for 300 seconds. Note that the reception strength determination unit 121 retains the current measured RSSI.

(S61) The radio communication unit 101 performs a normal scan in the same manner as in step S60. In this step, the measured RSSI is RSSI_11. Since RSSI_11>the scan threshold, and since RSSI_11≦the connection threshold, the reception strength determination unit 121 notifies the scan control unit 122 of a capturable state. Further, the reception strength determination unit 121 calculates the amount of RSSI change, that is, ΔRSSI_08. Since ΔRSSI_08>the walking threshold (ΔRSSI_03), the reception strength determination unit 121 estimates that the user is walking. The scan control unit 122 determines to perform a capture scan, and waits for 10 seconds.

(S62) The scan control unit 122 instructs the radio communication unit 101 to perform the first capture scan. The radio communication unit 101 transmits a unicast probe request, and receives a probe response from the access point 11. In this step, the measured RSSI is RSSI_15. Since RSSI_15>the scan threshold, and since RSSI_15≦the connection threshold, the reception strength determination unit 121 notifies the scan control unit 122 of a capturable state. Further, the reception strength determination unit 121 calculates an amount of RSSI change ΔRSSI_04, and determines that ΔRSSI_04>the walking threshold. The scan control unit 122 waits for 10 seconds.

(S63) The radio communication unit 101 performs the second capture scan in the same manner as in step S62. In this step, the measured RSSI is RSSI_16. Since RSSI_16>the scan threshold, and since RSSI_16≦the connection threshold, the reception strength determination unit 121 notifies the scan control unit 122 of a capturable state. Further, the reception strength determination unit 121 calculates an amount of RSSI change ΔRSSI_01. Since ΔRSSI_01≦the walking threshold, the reception strength determination unit 121 estimates that the user is stationary, and notifies the scan control unit 122 of a stationary state. Then, the scan control unit 122 determines not to perform subsequent capture scans.

(S64) The radio communication unit 101 performs a normal scan in the same manner as in step S60. In this step, the measured RSSI is RSSI_15. Since RSSI_15>the scan threshold, and since RSSI_15≦the connection threshold, the reception strength determination unit 121 notifies the scan control unit 122 of a capturable state. Further, the reception strength determination unit 121 calculates an amount of RSSI change ΔRSSI_01. Since ΔRSSI_01≦the walking threshold, the reception strength determination unit 121 notifies the scan control unit 122 of a stationary state. The scan control unit 122 determines not to perform a capture scan.

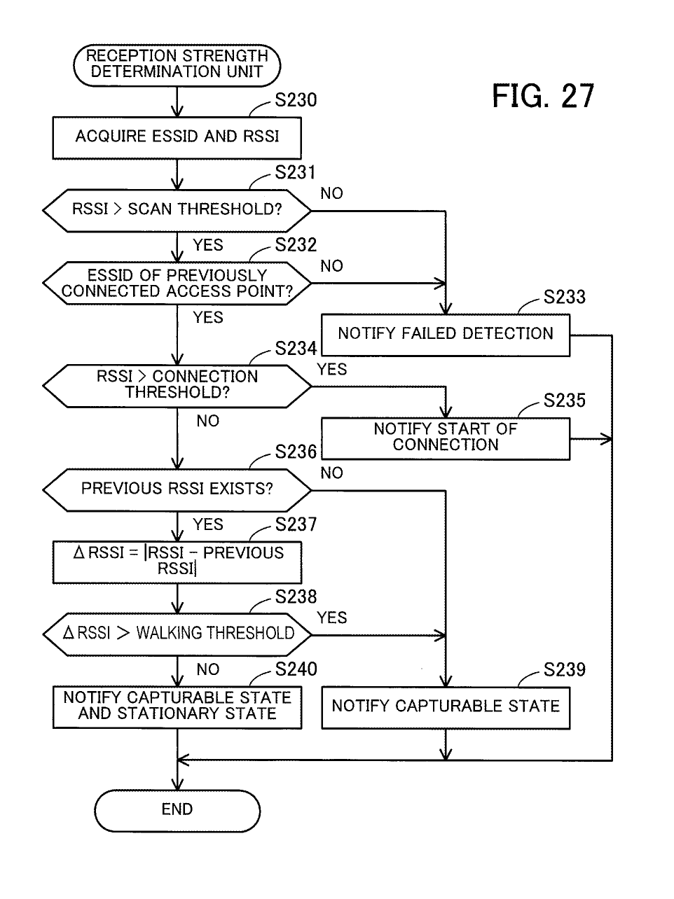

FIG. 27 is a flowchart illustrating an example of a sixth process performed by the reception strength determination unit 121.

(S230) The reception strength determination unit 121 acquires an ESSID and an RSSI. The reception strength determination unit 121 retains the acquired RSSI until the next scan.

(S231) The reception strength determination unit 121 determines whether the current RSSI is greater than the scan threshold. If the current RSSI is greater than the scan threshold, the process proceeds to step S232. If the current RSSI is less than or equal to the scan threshold, the process proceeds to step S233.

(S232) The reception strength determination unit 121 determines whether the ESSID is of an access point to which the mobile communication apparatus 100 has previously connected. If the ESSID is of a previously connected access point, the process proceeds to step S234. If the ESSID is not of a previously connected access point, the process proceeds to step S233.

(S233) The reception strength determination unit 121 notifies the scan control unit 122 of a failed detection. Then, the process by the reception strength determination unit 121 for the current scan ends.

(S234) The reception strength determination unit 121 determines whether the current RSSI is greater than the connection threshold. If the current RSSI is greater than the connection threshold, the process proceeds to step S235. If the current RSSI is less than or equal to the connection threshold, the process proceeds to step S236.

(S235) The reception strength determination unit 121 notifies the scan control unit 122 of the start of a connection. Then, the process by the reception strength determination unit 121 for the current scan ends.

(S236) The reception strength determination unit 121 determines whether the previous RSSI is retained. If the previous RSSI is retained, the process proceeds to step S237. If not, the process proceeds to step S239.

(S237) The reception strength determination unit 121 calculates an amount of RSSI change ΔRSSI. For example, ΔRSSI is an absolute value of the difference between the current RSSI and the previous RSSI.

(S238) The reception strength determination unit 121 refers to the threshold table 112 to determine whether ΔRSSI is greater than the walking threshold. If ΔRSSI is greater than the walking threshold, the process proceeds to step S239. If ΔRSSI is less than or equal to the walking threshold, the process proceeds to step S240.

(S239) The reception strength determination unit 121 notifies the scan control unit 122 of a capturable state.

(S240) The reception strength determination unit 121 notifies the scan control unit 122 of a capturable state. Further, the reception strength determination unit 121 notifies the scan control unit 122 of a stationary state.

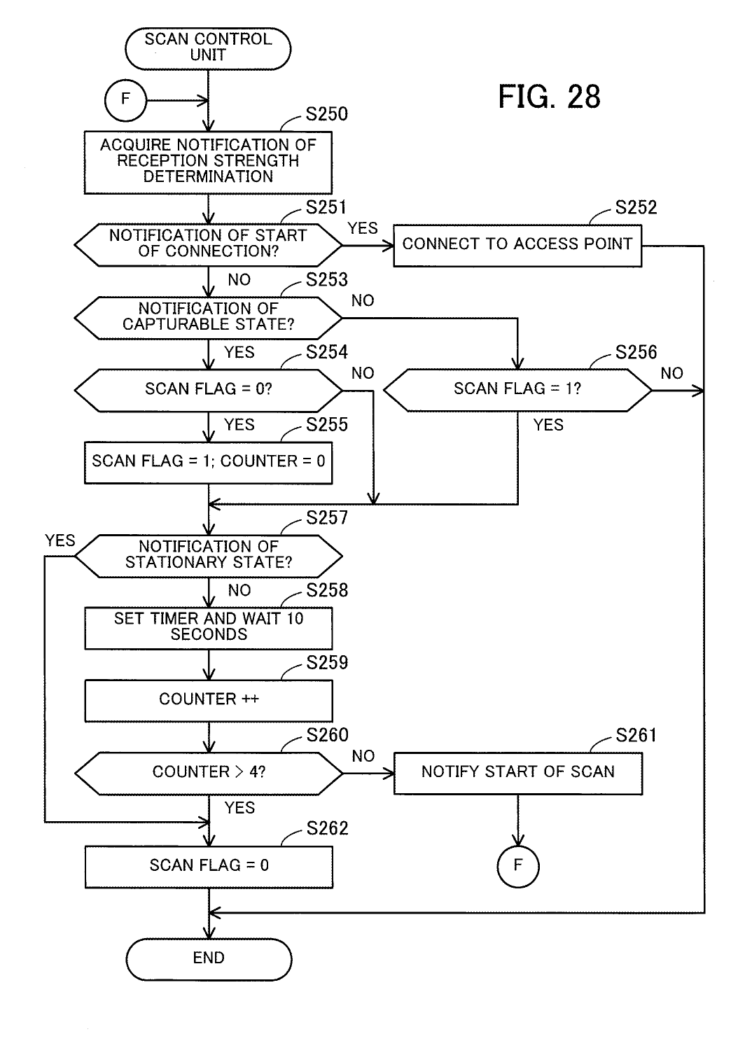

FIG. 28 is a flowchart illustrating an example of a sixth process performed by the scan control unit 122.

(S250) The scan control unit 122 obtains a notification from the reception strength determination unit 121.

(S251) The scan control unit 122 determines whether the notification indicates the start of a connection. If the notification indicates the start of a connection, the process proceeds to step S252. If not, the process proceeds to step S253.

(S252) The scan control unit 122 instructs the radio communication unit 101 to connect to the detected access point. Then, the process by the scan control unit 122 ends.

(S253) The scan control unit 122 determines whether the notification indicates a capturable state. If the notification indicates a capturable state, the process proceeds to step S254. If not, the process proceeds to step S256.

(S254) The scan control unit 122 determines whether the scan flag=0. If the scan flag=0, the process proceeds to step S255. If not, the process proceeds to step S257.

(S255) The scan control unit 122 updates the scan flag to 1, and initializes the counter to 0. Then, the process proceeds to step S257.

(S256) The scan control unit 122 determines whether the scan flag=1. If the scan flag=1, the process proceeds to step S257. If not, the process ends.

(S257) The scan control unit 122 determines whether the notification obtained from the reception strength determination unit 121 indicates a stationary state together with a capturable state. If the notification indicates a stationary state, the process proceeds to step S262. If the notification does not indicate a stationary state, the process proceeds to step S258.

(S258) The scan control unit 122 sets the timer and waits for 10 seconds to elapse.

(S259) The scan control unit 122 increments the counter by 1.

(S260) The scan control unit 122 determines whether the counter is greater than 4. If the counter is greater than 4, the process proceeds to step S262. If not, the process proceeds to step S261.

(S261) The scan control unit 122 notifies the radio communication unit 101 of the start of a scan. Thus, a capture scan is performed. Then, the process proceeds to step S250.

(S262) The scan control unit 122 updates the scan flag to 0.

According to the mobile communication system of the fourth embodiment, the same effects as those in the second and third embodiments are obtained. Further, according to the fourth embodiment, it is possible to estimate the walking status of the user based on the change in RSSI, without using the walking sensor 108. This makes it possible to reduce the number of times a scan is performed, and thus to reduce the power consumption of the mobile communication apparatus 100.

As mentioned above, the processing in the first embodiment may be implemented by causing the mobile communication apparatus 1 to execute a communication control program. Further, the processing in the second through fourth embodiments may be implemented by causing the mobile communication apparatus 100 to execute a communication control program.

The communication control program may be recorded in a computer-readable storage medium. Examples of storage media include magnetic disks, optical discs, magneto-optical disks, semiconductor memories, and the like. Magnetic disks include FD and HDD. Optical discs include CD, CD-Recordable (CD-R), CD-Rewritable (CD-RW), DVD, DVD-R, and DVD-RW. The communication control program may be stored in a portable storage medium and distributed. In this case, the communication control program may be copied from the portable storage medium to another storage medium (for example, the non-volatile memory 104) and executed.

According to one aspect, it is possible to quickly connect to an access point.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A mobile communication apparatus comprising:
a radio interface configured to perform a search for an access point; and
a processor configured to allow a connection to an access point detected by the search when a signal level of a signal received from the detected access point is greater than a first threshold, and to determine an interval to a next search in accordance with whether the signal level is greater than a second threshold when the signal level is less than or equal to the first threshold, the second threshold being less than the first threshold.

2. The mobile communication apparatus according to claim 1, wherein when the signal level is greater than the second threshold, the processor sets the interval to the next search to be shorter than an interval that is set when the signal level is less than or equal to the second threshold.

3. The mobile communication apparatus according to claim 1, wherein when the signal level is greater than the second threshold, the processor performs control such that a search for an access point is successively performed a plurality of times at predetermined intervals, the predetermined intervals being shorter than intervals at which a search for an access point is performed when the signal level is less than or equal to the second threshold.

4. The mobile communication apparatus according to claim 1, wherein the processor sets the interval to the next search to be equal to or longer than an immediately preceding interval when the signal level is less than or equal to the second threshold, and sets the interval to the next search to be shorter than the immediately preceding interval when the signal level is greater than the second threshold.

5. The mobile communication apparatus according to claim 1, wherein the processor limits channels to be subjected to the next search to one or more channels including a channel used by the detected access point, and a number of channels to be subjected to the next search is less than a number of channels subjected to the search.

6. The mobile communication apparatus according to claim 1, further comprising:
a sensor configured to detect a movement of the mobile communication apparatus;
wherein when the signal level is greater than the second threshold, the processor determines the interval to the next search in accordance with whether a movement of the mobile communication apparatus is detected.

7. The mobile communication apparatus according to claim 1, wherein the processor calculates a difference between the signal level and a signal level of a previous signal received from the detected access point, and determines the interval to the next search in accordance with the calculated difference when the signal level is greater than the second threshold.

8. A radio communication method comprising:
performing, by a mobile communication apparatus, a search for an access point;
allowing, by the mobile communication apparatus, a connection to an access point detected by the search, when a signal level of a signal received from the detected access point is greater than a first threshold; and
determining, by the mobile communication apparatus, an interval to a next search in accordance with whether the signal level is greater than a second threshold, when the signal level is less than or equal to the first threshold, the second threshold being less than the first threshold.

9. A non-transitory computer-readable storage medium storing a computer program that causes a computer included in a mobile communication apparatus to perform a procedure comprising:
causing the mobile communication apparatus to perform a search for an access point;
allowing a connection to an access point detected by the search, when a signal level of a signal received from the detected access point is greater than a first threshold; and
determining an interval to a next search in accordance with whether the signal level is greater than a second threshold, when the signal level is less than or equal to the first threshold, the second threshold being less than the first threshold.
